(19) United States
(12) Patent Application Publication
(10) Pub. No.: US 2026/0319850 A1
(43) Pub. Date: Oct. 15, 2026

(54) Modular ML Workflows For Actionable Insights From Natural Language

(71) Applicant: INSIGHTBOX AI INC., Torrance, CA (US)

(72) Inventor: Yunlan Lan, Torrance, CA (US)

(21) Appl. No.: 19/292,432

(22) Filed: Aug. 6, 2025

Related U.S. Application Data
(60) Provisional application No. 63/830,910, filed on Jun. 26, 2025.
(60) Provisional application No. 63/786,689, filed on Apr. 10, 2025.

(51) Int. Cl. G06F 9/50

(52) U.S. Cl. CPC G06F 9/5027

(57) ABSTRACT

A natural language input from a user specifying a challenge or objective is received. The input is processed using a retrieval-augmented generation (RAG) engine and context-augmented guidance (CAG) engine to identify one or more relevant machine learning modules from a predefined library. A modular execution pipeline that includes the identified modules is dynamically configured by resolving interdependencies using dependency graph analysis that models modules as nodes and inter-module data dependencies as edges. Goal-aware cleansing of user-provided data is applied. The goal-aware cleansing is based on data requirements of at least one of the identified modules. The modular pipeline is executed on the cleansed data to generate actionable insights. The actionable insights are then transmitted to a client device.

### CROSS REFERENCE TO RELATED APPLICATIONS

This application claims priority to and the benefit of U.S. Provisional Patent Application Serial Number 63/830,910, filed Jun. 26, 2025, and U.S. Provisional Patent Application Serial Number 63/786,689, filed Apr. 10, 2025, the entire disclosures of which are incorporated herein by reference.

### FIELD

This disclosure generally relates to automated machine learning (ML) systems, and more specifically to modular ML workflows with actionable insights from natural language.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system (e.g., a system), which may be or include a distributed computing system, a cloud computing architecture, a virtualized orchestration platform, or another type of networked computing environment.

FIG. 2 is a block diagram showing an example of a computing device which may be used in a modular intelligence orchestration system, for example, the system shown in FIG. 1.

FIG. 3A is an example of a technique for dynamically constructing and executing modular analytical workflows based on natural language inputs.

FIG. 3B illustrates an example of a technique for automated module recommendation and pipeline configuration by dynamically processing natural language inputs through coordinated recommendation and configuration engines within the MIO platform.

FIG. 3C illustrates an example of module registry entries within the mapping of FIG. 3A.

FIG. 4 illustrates an internal structure of a composable module of the module library of FIG. 3A.

FIG. 5A illustrates an example of a technique for transforming a user-defined marketing challenge into actionable insights using the modular AI-driven system described in FIGS. 1 through 4.

FIG. 5B illustrates an example of a user interface via which the user can provide input.

FIG. 5C illustrates a user interface of recommended modules.

FIG. 5D is an example of a user interface that illustrates the visualization and interpretation dashboard generated by the technique.

FIG. 5E illustrates an example of a user interface generated by the technique of FIG. 5A.

FIG. 5F illustrates an example of a user interface generated by the technique of FIG. 5A showing an interpretation dashboard with expandable content sections.

FIG. 5G illustrates an example of a user interface generated by the technique of FIG. 5A showing detailed analytical findings within the interpretation dashboard.

FIG. 5H illustrates an example of a user interface demonstrating the Reporter AI agent functionality within the MIO platform.

FIG. 5I illustrates an example of a user interface demonstrating expert AI agent functionality within the MIO platform.

FIG. 6 illustrates an interaction diagram for the automated module recommendation and journey analysis process within the MIO platform.

FIG. 7 is a flowchart of an example of a technique associated with modular ML workflows for actionable insights from natural language.

### DETAILED DESCRIPTION

In data-intensive environments, organizations increasingly depend on computer-implemented systems to extract meaningful insights from large, complex, and often disorganized datasets. These datasets may originate from diverse sources and require careful analysis to support strategic or operational decision-making. A limitation of current systems is their inability to operate effectively when user objectives are expressed at a high level, particularly in natural language. In practice, users must translate their intended goals into specific technical instructions, such as model selection, data preprocessing configurations, and workflow assembly steps. This manual translation process demands significant expertise and imposes a barrier between strategic intent and technical execution.

A technical challenge in the domain of computer-implemented data analytics systems is the orchestration of analytical workflows composed of modular components, where systems must determine how to select, sequence, and configure these components in response to diverse, evolving user-defined goals and domain-specific contexts. To illustrate, the concept of “customer loyalty” may require different analytical treatments (e.g., different machine learning (ML) algorithms) depending on whether the target population is composed of baseball fans, basketball season ticket holders, or retail consumers.

Existing systems typically rely on static configurations or require manual assembly of workflows, which severely limits their flexibility and scalability. The underlying problem is combinatorial in nature. In systems with large libraries of analytical modules (e.g., clustering, scoring, segmentation), the exponential growth of possible module-algorithm combinations makes it practically impossible to select, sequence, and configure them in a valid, efficient, and contextually meaningful manner, rendering manual orchestration impractical. This complexity is compounded by the internal architecture of the modules themselves, many of which embed multiple ML algorithms that must also be tuned, ordered, and interpreted correctly within each module.

Current technologies are also constrained by rigid data preparation pipelines that fail to adapt to downstream analytical needs. To illustrate, conventional systems apply uniform cleansing, transformation, and integration routines regardless of the particular downstream ML models or tasks that follow. This results in pipelines that may inadvertently introduce noise, discard important variation, overfit to irrelevant features, or completely miss highly relevant and necessary features for particular analytics or algorithms. Moreover, traditional data preparation lacks any awareness of model-specific sensitivity or performance patterns. The inability to adapt data preprocessing steps to the structure and requirements of dynamically assembled analytical workflows contributes to degraded performance and reduces the overall utility of any insights produced. Furthermore, insight generation remains manual, disjointed, and lacks interpretability or contextual reasoning powered by executive model layers.

Another technical deficiency in conventional systems is the absence of semantic reasoning and explainability as integrated, first-class components of the machine learning pipeline. Current solutions often treat interpretability as a post-processing activity rather than a core design principle. This leads to outputs that are difficult to contextualize, audit, or act upon, particularly in domains where understanding behavioral drivers or rationale is essential. Additionally, existing platforms typically do not include mechanisms to incorporate feedback from model outcomes or user interaction into future pipeline configuration decisions. Without these adaptive feedback loops, systems cannot improve over time, nor can they respond dynamically to changes in input data or evolving user goals.

These challenges highlight a critical gap in current technologies for workflow orchestration, dynamic data preprocessing, semantic feature engineering, and integrated feedback-driven optimization in machine learning systems. There is a need for computer-implemented systems capable of automatically constructing, executing, and refining modular, multi-stage analytical workflows based on high-level, user-defined objectives. Such systems must be able to manage the full combinatorial complexity of selecting and ordering modules and their internal algorithms, dynamically adapt preprocessing steps to the requirements of each workflow, and support integrated semantic reasoning and explainability. Absent such capabilities, users remain dependent on manual intervention, limiting the reach, agility, and impact of data-driven decision-making in complex and dynamic environments.

Implementations according to this disclosure address problems such as these via a Modular Intelligence Orchestration (MIO) software platform. The MIO platform automatically constructs and executes domain-specific analytical workflows by processing natural language inputs specifying user objectives, utilizing a recommendation engine with retrieval-augmented generation (RAG) and context-augmented guidance (CAG) to select and sequence ML modules from a registry of specialized components. RAG functions as the retrieval mechanism that dynamically identifies potentially relevant modules and workflow components from stored knowledge, while CAG serves as the refinement mechanism that applies domain-specific constraints and contextual information to optimize module selection for the user's specific industry and objectives.

A configuration engine of the MIO platform may employ dependency graph analysis and semantic scoring to configure modular workflows through stacked ML reasoning layers, including embedded models for logic-based reasoning, clustering, predictive scoring, and explainability, assembling modules into a modular execution pipeline that maintains valid data flows and performs context-sensitive optimization of the analytical solution. The dependency graph analysis may include recursive dependency resolution capabilities, where complex module interdependencies are systematically resolved through iterative graph traversal algorithms that result in valid execution sequences even for deeply nested or circular module relationships. This technical advancement overcomes the combinatorial complexity of traditional systems, enabling non-technical users to leverage advanced analytics for actionable insights across diverse domains.

The configuration engine uses RAG to retrieve candidate modules based on user intent and CAG to refine selections by applying domain-specific rules, such as prioritizing fan engagement modules for sports-related objectives over generic metrics. To illustrate, in response to a user input “increase subscription renewals,” the MIO platform triggers RAG to surface specialized modules such as loyalty scoring, while CAG ensures alignment with the user’s industry context (e.g., ticketing for baseball). The configuration engine then constructs a modular execution pipeline using dependency graph analysis, modeling modules as nodes and data dependencies as edges to resolve execution order. Semantic scoring may be used to rank potential module sequences for relevance. Alternative implementations may employ rule-based intent parsing instead of or in addition to RAG, use heuristic-based dependency resolution, or support asynchronous module execution for real-time applications.

Each module includes a composable algorithm stack that integrates one or more of dimensionality reduction (e.g., Principal Component Analysis (PCA), t-distributed Stochastic Neighbor Embedding (t-SNE)), executive logic reasoning for deriving semantically and context-specific rich features (e.g., loyalty, price sensitivity), clustering (e.g., KMeans, Density-Based Spatial Clustering of Applications with Noise (DBSCAN)), predictive models (e.g., XGBoost, Random Forest), and explainability layers (e.g., SHapley Additive exPlanations (SHAP), Local Interpretable Model-agnostic Explanations (LIME)).

By implementing executive logic reasoning as an upfront phase, modules can derive semantically rich features before statistical modeling, thereby enhancing interpretability. In this architecture, logical reasoning precedes statistical analysis: first inferring meaningful behavioral features from raw data, then applying mathematical models to those interpreted features. This approach enhances interpretability and alignment with user goals. Additionally, it creates auditable decision pathways where each analytical step can be traced and validated. This addresses the “black-box” limitations of conventional ML systems that process raw data directly without intermediate semantic interpretation.

The data ingestion component of the MIO platform implements goal-aware data preparation, dynamically adjusting cleansing and transformation based on downstream module requirements, such as preserving categorical variability for clustering tasks or prioritizing imputation for price sensitivity features. Metadata-aware processing considers data lineage and freshness to optimize preprocessing. Alternative implementations may support streaming data inputs or integrate third-party data sources via Application Programming Interfaces (APIs).

The MIO platform delivers multi-layered insight delivery through visual dashboards with specialized tabs (e.g., propensity metrics, pricing strategies, behavioral patterns, demographics), AI-generated textual summaries, predictive scores, and activation-ready datasets for integration with external platforms like customer data platforms or demand-side platforms. The MIO platform may include AI interpreter agents that include a Reporter Agent that is data-query-focused and an Expert Agent that is strategy-focused, both referencing outputs from analytical modules within the module library. Reporter and expert artificial intelligence (AI) agents enable conversational interaction, translating queries into, for example, structured query language (SQL)-based outputs or strategic recommendations using RAG and CAG techniques applied to module-generated analytical results, where the Reporter Agent focuses on data extraction and database interrogation while the Expert Agent processes semantic features and behavioral insights derived from executed modules to formulate strategic guidance.

A feedback-driven learning mechanism refines module selection, pipeline assembly, and preprocessing by incorporating user validations and performance metrics, with user-configurable retraining cadences (e.g., monthly, event-driven). Alternative implementations may include voice-based agent interfaces, real-time streaming pipelines, or industry-specific module libraries, ensuring scalability and adaptability across domains.

As used herein, modular execution pipeline refers to a dynamically assembled sequence of ML modules processing data to generate insights, e.g., chaining segmentation, loyalty scoring, and prediction modules; alternative implementations may support parallel or recursive pipelines.

As used herein, “module” refers to a self-contained algorithmic unit performing specific analytical tasks, e.g., a loyalty module deriving scores via a composable algorithm stack, which modularly combines components like preprocessing, reasoning, modeling, and explanation (e.g., PCA, KMeans, SHAP), with alternatives like rule-based or custom preprocessing modules. Executive logic reasoning derives semantically rich features, e.g., loyalty from engagement data, using probabilistic models or neural networks as alternatives. Reasoning-first architecture infers behavioral features before statistical modeling to enhance interpretability, e.g., deriving loyalty before clustering, with hybrid approaches as alternatives. “Reasoning-first” here means that latent behavioral dimensions (e.g., loyalty and fandom in the case of marketing-related objectives) are derived via embedded reasoning models before segmentation or prediction layers are applied. Goal-aware data preparation adapts preprocessing to downstream module needs, e.g., preserving categorical data for clustering, with automated feature selection or real-time preprocessing as alternatives.

While the description herein refers to specific module names in the sports context for generating marketing campaigns, the disclosure is not so limited and can be applied to a wide range of domains and use cases involving goal-directed data analytics. Examples include applications in healthcare (e.g., patient risk stratification), financial services (e.g., fraud detection or customer lifetime value modeling), logistics (e.g., demand forecasting and route optimization), human resources (e.g., attrition prediction and workforce planning), and public policy (e.g., resource allocation or citizen engagement analysis). The system’s architecture is domain-agnostic and can ingest and process structured or unstructured data from any vertical to assemble modular pipelines for insight generation, decision support, or operational automation based on natural language inputs.

In particular, the modular configuration, semantic scoring, reasoning-first architecture, and explainability components described herein may be adapted for any problem domain where a user-defined objective must be translated into a structured analytical workflow. Accordingly, references to specific industries, use cases, or module names are provided for illustrative purposes only and should not be construed as limiting the scope of the disclosed invention.

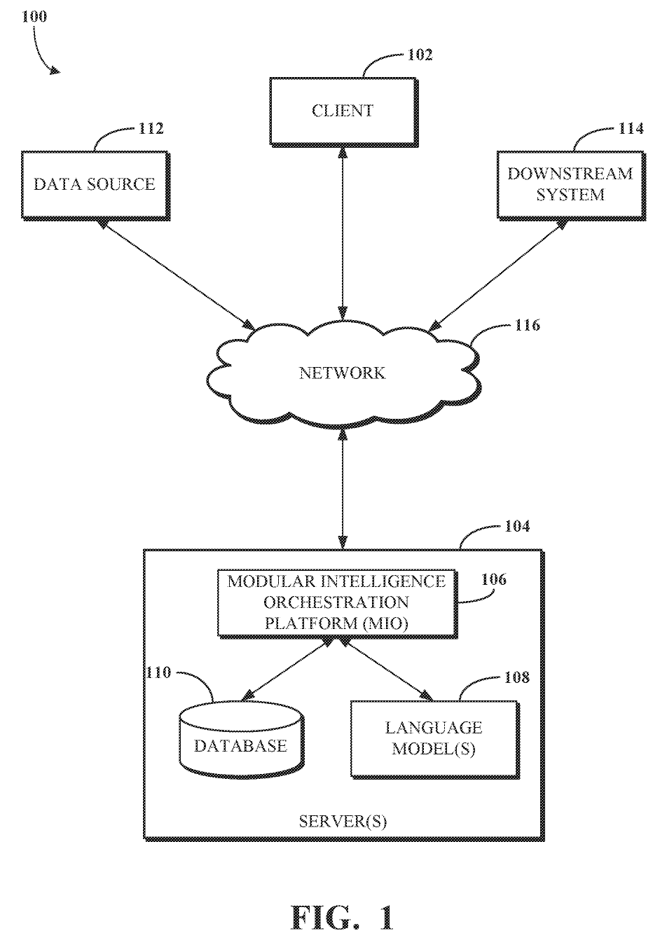

To describe some implementations in greater detail, reference is first made to examples of hardware and software structures used to implement a system for persistent chat continuity across collaborative sessions. FIG. 1 is a block diagram of an example of an electronic computing and communications system (e.g., a system 100), which may be or include a distributed computing system, a cloud computing architecture, a virtualized orchestration platform, or another type of networked computing environment. The system 100 is configured to enable processing of natural language inputs to automatically construct and execute domain-specific analytical workflows through a modular intelligence orchestration process. As illustrated, the system 100 includes a client 102, a server 104, an MIO platform 106, a language model 108, a database 110, a data source 112, a downstream system 114, and a network 116 interconnecting these elements.

In certain implementations, the system 100 may be configured as a software-as-a-service (SaaS) platform, enabling organizations to access the MIO platform 106 through cloud-based subscription models. As can be appreciated, such SaaS deployment approach eliminates the need for local infrastructure management while providing scalable access to the full library of analytical modules and processing capabilities.

The client 102 is a computing device or interface through which a user interacts with the server 104. The client 102 may include hardware devices such as laptops, desktop computers, tablets, or smartphones. The client 102 may also include software applications, such as mobile apps, browser-based interfaces, or dedicated enterprise software environments. The client 102 enables users to submit challenges, goals, queries, or commands, expressed in natural language, such as “segment high-value customers,” “forecast quarterly churn,” or “predict the ROI of a marketing campaign.”

The server 104 includes one or more computing nodes responsible for hosting components of the MIO platform 106. As such, the server 104 can be one or more servers. The nodes may include physical servers, virtual servers, containerized environments, or combinations thereof deployed in a centralized or distributed configuration. The server 104 may support containerized microservices, serverless execution environments, or hybrid cloud deployments across geographic regions. As further described herein, different functions of the MIO platform 106 may be implemented by discrete server instances, such as orchestration services, execution environments, and analytics backends. In some implementations, edge computing nodes may support parts of the server 104 to minimize latency for real-time or localized tasks.

The MIO platform 106 is a software platform executed by the server 104 to process natural language inputs and dynamically constructs modular machine learning pipelines to fulfill user-specified objectives. In response to user input, the MIO platform 106 orchestrates the selection, assembly, and execution of ML modules by leveraging information from the language model 108 and historical usage stored in the database 110. The MIO platform 106 includes a registry of specialized modules.

As already mentioned, a module may be structured as a composable stack of algorithmic components and configured to implement one or more analytical procedures tailored to the problem the module is designed to address. The MIO platform 106 may include hundreds or even thousands of such modules, each targeting a distinct problem that may be industry-specific or industry-agnostic. For example, modules may be designed to perform analytical tasks, generate predictions, recommend actions, or extract semantic patterns from complex datasets. To illustrate, and without limitation, modules tailored for marketing applications in the sports industry may include a Fan Propensity AI module, an Advocate Advisor module, and a Loyalty Loop module, among others.

The Fan Propensity AI module estimates the likelihood that a specific fan will make high-value purchases, such as season tickets or streaming upgrades, based on behavioral signals, transaction histories, and engagement patterns. The Advocate Advisor module identifies loyal fans statistically likely to act as brand ambassadors, enabling marketing teams to initiate peer-to-peer outreach campaigns that strategically amplify word-of-mouth advocacy. The Loyalty Loop module analyzes sustained fan engagement patterns to identify fans likely to remain active regardless of team performance, supporting targeted messaging strategies such as personalized offers or exclusive access to increase repeat attendance. These modules may be adapted for non-sports industries, including subscription media, retail loyalty programs, or business-to-business (B2B) customer retention.

The language model 108 may include one or more language models configured to interpret natural language input and generate module recommendations. The language model 108 operates within or in conjunction with the MIO platform 106 to support user input analysis, workflow assembly, and query response generation. In some implementations, the language model 108 includes a transformer-based architecture, such as a fine-tuned large or small language model (LLM or SLM), structured as a combination of pre-trained foundation models and domain-specific tuning layers. The language model 108 may support techniques such as RAG to retrieve relevant analytical components and CAG, a technique that refines recommendations based on industry or application context by incorporating domain-specific knowledge and constraints.

The language model 108 may access module metadata and descriptions stored in the database 110 to inform its recommendations. To illustrate, a user query such as “improve lifetime value” may trigger RAG to retrieve modules like customer retention or revenue optimization from the module registry, while CAG subsequently refines these selections based on the identified domain context (e.g., prioritizing churn prediction modules for telecom versus cross-sell optimization modules for retail). The language model 108 may also employ example-based learning techniques, where historical successful module combinations and workflow patterns are used as templates to guide current module selection and pipeline configuration decisions. This example-based approach leverages proven workflow templates from similar objectives and domains to accelerate recommendation accuracy and reduce configuration complexity.

The database 110 is a data store for system configurations, module metadata, pipeline definitions, performance logs, user profiles, and other information necessary to support orchestration. The database 110 may also store imported data that is usable by the MIO platform 106 and results generated by the MIO platform 106 during or after pipeline execution. The database 110 may be implemented using a relational model (e.g., PostgreSQL), NoSQL model (e.g., MongoDB), or hybrid data architecture. The database 110 may support distributed querying and replication to ensure high availability and scalability. The database 110 may also include caches for frequently accessed configurations or precomputed intermediate outputs. The database 110 may incorporate graph-based schema to represent module interdependencies, audit logs, or lineage tracking for compliance and interpretability.

The data source 112 represents one or more input channels through which data is supplied to the MIO platform 106 for analysis. Examples of the data source 112 include user-uploaded files, database connectors, API integrations with a system that can be a data source, or through secure API access to remote cloud-based storage, including encryption and schema validation. The data source 112 may be customer relationship management (CRM) platform, a cloud data lake, a third-party syndicated dataset, other data source, or a combination thereof. The data source 112 may provide real-time event streams (e.g., clickstream data, internet-of-things (IoT) sensor telemetry) or historical transactional records. The data source 1s12 may include first-party or second-party datasets to supplement first-party data for enhanced analysis. Any specific terms used for indicating how the MIO platform 106 ingests the data to be analyzed are non-limiting and should be understood to encompass any way that the MIO platform 106 can receive, access, retrieve, or obtain data from internal or external sources for subsequent analytical processing.

The downstream system 114 is a recipient system or process that utilizes the outputs generated by the MIO platform 106 after execution of an analytical workflow. Examples of the downstream system 114 include, but are not limited to, a marketing platform, a CRM system, a customer data platform (CDP), a demand-side platform (DSP), or a call center management system. Other examples include a business intelligence tool, a visualization interface, or an autonomous process that can be configured to take actions based on the MIO-generated outputs. The downstream system 114 may receive structured outputs such as delimited data (e.g., comma-separated values (CSVs)), structured data (e.g., JavaScript Object Notation (JSON) files), real-time streams via event buses, or synchronous responses over secure APIs.

The network 116 facilitates communication among the various components shown in FIG. 1. The network 116 may be or include local and wide area networks (LAN/WAN), the Internet, or a virtual private network (VPN), and may support communication protocols such as Hypertext transfer protocol secure (HTTPS), WebSockets, and/or proprietary messaging formats. The network 116 enables transmission of natural language inputs from the client 102 to the server 104, delivery or retrieval of data from the data source 112, and return of outputs to the client 102 or downstream system 114.

In some implementations, the server 104 hosts multiple versions of the MIO platform 106 or supports multi-tenant isolation, enabling organizations to maintain separate analytical contexts while sharing infrastructure. The language model 108 may also support runtime model selection based on user attributes, organizational settings, or workflow complexity. In alternative implementations, workflows may be triggered programmatically via external orchestration systems or operate in batch mode to support scheduled tasks and report generation.

Unlike generic AI agents that rely solely on model pretraining or public data, the MIO platform 106, and as further described herein, implements an Expert Agent that accesses a curated corpus of real-world strategic knowledge hand-authored by marketing executives, strategists, and data leaders with direct experience driving results across industries like sports, real estate, health, and e-commerce. The MIO platform 106 incorporates strategic knowledge authored by former chief marketing officers (CMOs), vice presidents (VPs) of Growth, Revenue Strategists, experienced Data Scientists with vertical-specific expertise, and consultants who have deployed and tested pricing and segmentation strategies with large revenue impact.

Each strategy block stored in the database 110 includes the user problem statement such as “low conversion on 20-game package,” module-derived audience insight such as “cluster shows low fandom but high price sensitivity,” strategy applied such as “add $5 discount + urgency messaging during schedule release week,” observed or modeled uplift such as “2.5x increase in conversion under time-limited framing,” and lessons learned from past campaigns.

The human-curated strategy corpus includes several key components that enable comprehensive strategic guidance. Case records document outcomes and learnings from past client deployments, annotated by outcome such as “Fan Cluster 3 responded best to tiered pricing.” Journey-to-strategy mappings provide structured mappings between common user inputs and successful strategy outcomes, such as a journey to increase 40-game ticket package sales with input conditions of low enthusiasm plus high price sensitivity leading to a strategy mapping that recommends urgency-based messaging plus $5 off weekday tiered pricing. Vertical-specific templates provide playbooks tailored to industries such as MLB, Real Estate, and D2C health, including pricing bands, segmentation logic, and creative suggestions. Insight narratives comprise short, explanatory paragraphs written by domain experts that interpret module outputs into plain-English findings.

As used herein, a “journey” refers to a predefined analytical workflow template that maps specific business objectives to optimized module sequences and configurations. For example, a journey titled “Boost Partial Plan Upgrades” may include a sequence of modules such as segmentation, price sensitivity estimation, and upgrade propensity scoring specifically designed for sports industry applications.

These strategic assets are stored in a searchable vector database within the database 110, optimized for retrieval by the RAG engine. This approach enables the MIO platform 106 to provide recommendations that are grounded in proven strategies and real-world marketing experience rather than generic algorithmic outputs, ensuring that users receive contextually relevant and actionable guidance based on demonstrated results from similar business situations.

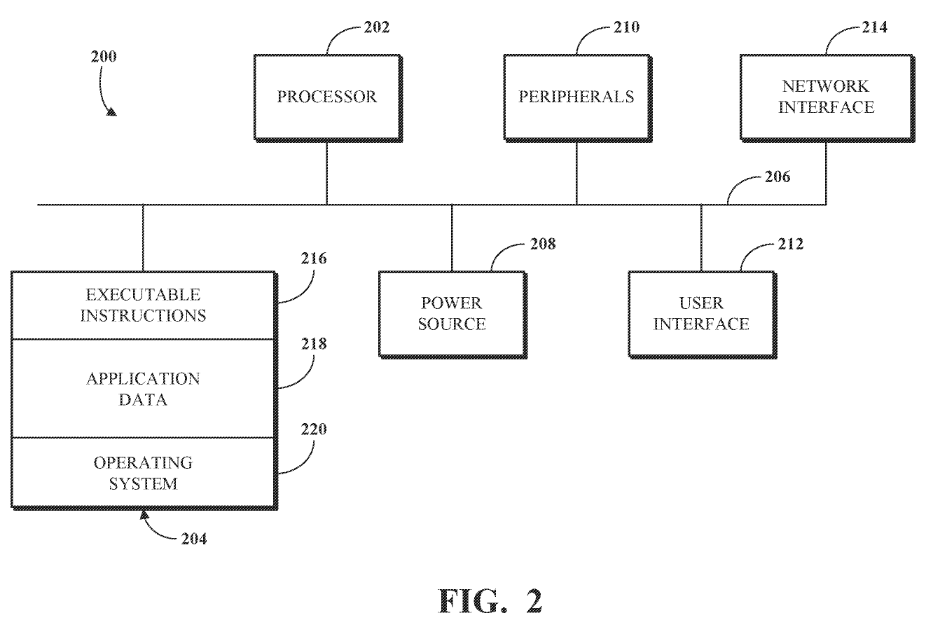

FIG. 2 is a block diagram showing an example of a computing device 200 which may be used in a modular intelligence orchestration system, for example, the system 100 shown in FIG. 1. The computing device 200 may be used to implement a server on which a software application is run (e.g., the server 104 and the MIO platform 106 shown in FIG. 1). Alternatively, the computing device 200 may be used to implement a client that accesses the software application or platform (e.g., the client 102 shown in FIG. 1). As a further alternative, the computing device 200 may be used as or to implement another client, server, or other device according to the implementations disclosed herein. The computing device 200 includes components or units, such as a processor 202, a memory 204, a bus 206, a power source 208, peripherals 210, a user interface 212, and a network interface 214. One of more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data and/or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid state drive, flash memory, phase-change memory, or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, a general-purpose operating system, a mobile device operating system, a mainframe operating system, or some other operating system. To illustrate, the operating system 220 can be Microsoft Windows®, Mac OS X®, or Linux®; an operating system for a small device, such as a smartphone or tablet device; or an operating system for a large device, such as a mainframe computer.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system. The peripherals 210 includes one or more sensors, detectors, or other devices configured for monitoring the computing device 200 or the environment around the computing device 200. For example, the peripherals 210 can include a geolocation component, such as a global positioning system location unit.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 116 shown in FIG. 1). The network interface 214 can be a wired network interface or a wireless network interface. The computing device 200 can communicate with other devices via the network interface 214 using one or more network protocols, such as Ethernet, Transmission Control Protocol (TCP), Internet Protocol (IP), power line communication, Wireless Fidelity (Wi-Fi), Bluetooth, infrared, General Packet Radio Service (GPRS), Global System for Mobile Communications (GSM), Code Division Multiple Access (CDMA), Z-Wave, ZigBee, another protocol, or a combination thereof.

Implementations of the computing device 200 may differ from what is shown and described with respect to FIG. 2. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

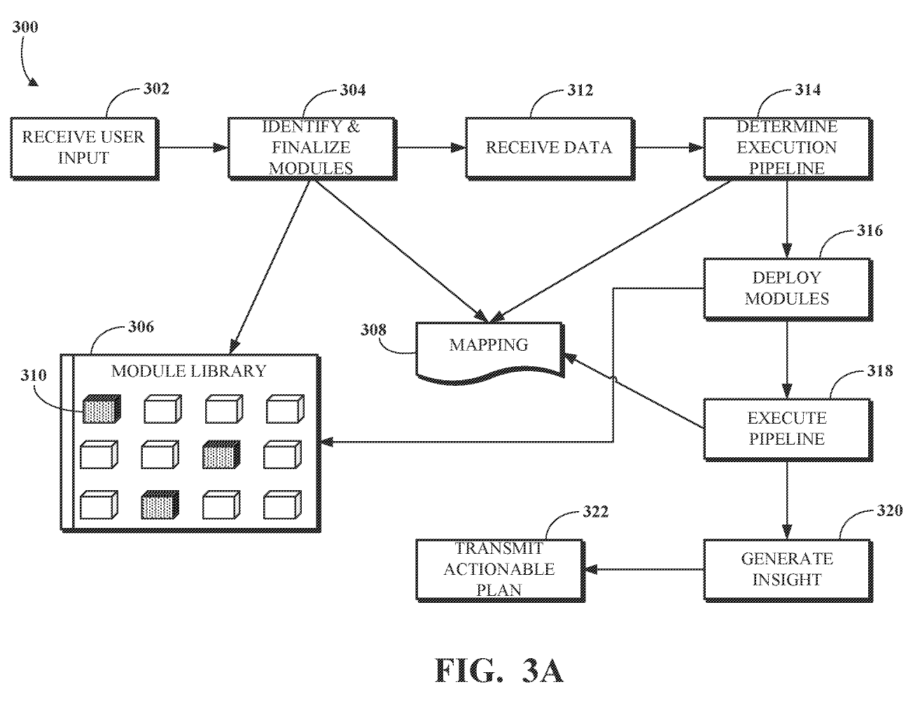

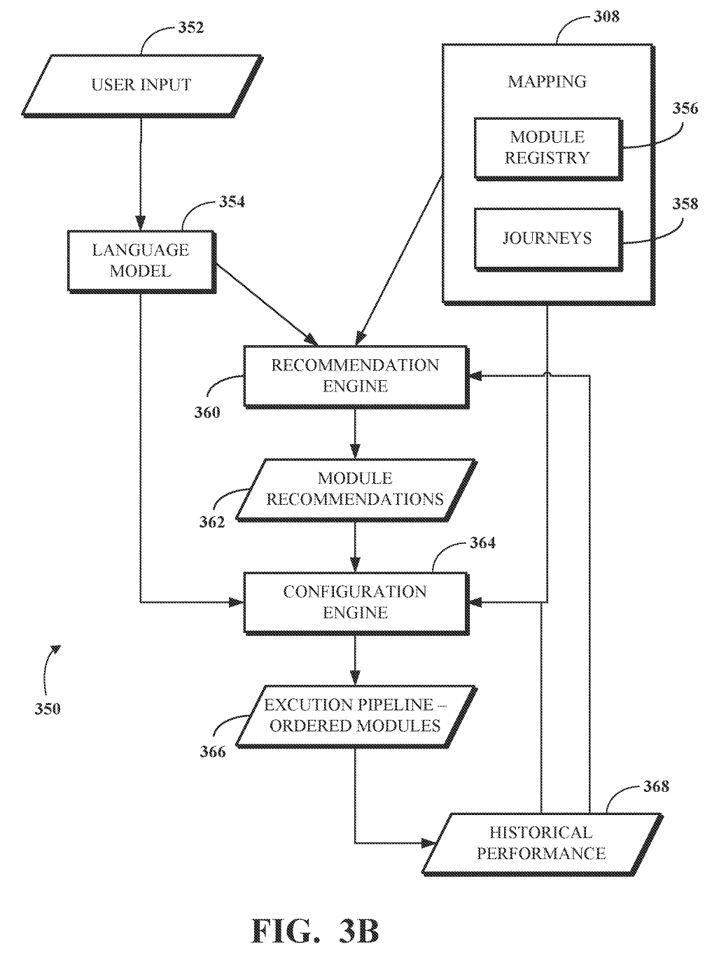

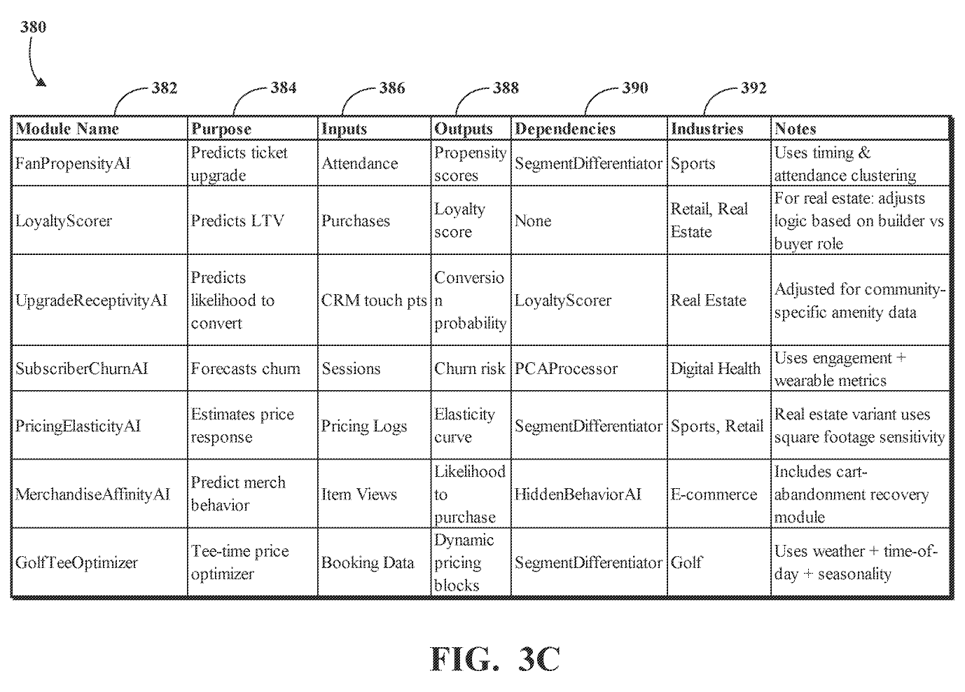

FIG. 3A is an example of a technique 300 for dynamically constructing and executing modular analytical workflows based on natural language inputs. The technique 300 can be implemented by the system 100 of FIG. 1 and, more specifically, by the MIO platform 106 of FIG. 1.

At step 302, the technique 300 receives user input. The input may include a goal, a challenge, or a description of a particular problem domain (e.g., baseball), such as sports marketing use cases (e.g., for baseball). In some implementations, inputs may be natural language statements. To illustrate, with respect to the domain, the user may enter “Baseball,” and may provide a challenge (e.g., “we have been on a losing streak for the past 8 months and our ball park has been only 80% full”) and a goal for the technical analysis to be performed (e.g., “I want to know who are the loyal fans that I can reach out to and make them come out to see us, win or lose”). Other examples of goals may be “I want to increase subscription renewals,” “optimize pricing for season tickets,” or “we have improve customer lifetime value.”

At step 304, the technique 300 identifies and finalizes modules from a module library 306 to address the user input. This can be an iterative process where, based on the user inputs, the technique 300 automatically identifies potential modules from a module library 306 and presents the identified modules to the user. The user may then select a subset of modules for execution. The module library 306 may implement version control capabilities, enabling tracking of module iterations, rollback functionality, and systematic management of algorithmic updates across the registry of specialized components.

FIG. 3A illustrates that the user has selected the three shaded modules, such as a module 310, thereby finalizing the modules to be executed for solving the problem (e.g., objective, challenge, etc.) defined by the user input.

The technique 300 identifies the modules using a combination of a language model, such as the language model 108, and a mapping 308. Input processing and module selection are implemented using retrieval-augmented generation (RAG) to dynamically retrieve potentially relevant modules and workflow components from a large corpus that includes module definitions, configurations, and journey templates. In this context, a ‘journey’ represents a predefined analytical workflow template that maps specific business objectives to optimized module sequences and configurations. Said another way, a ‘journey’ may represent a predefined strategy-to-module mapping pattern corresponding to common domain-specific objectives (e.g., marketing-campaign related objectives). For example, a journey titled “Boost Partial Plan Upgrades” may include a sequence of modules such as a segmentation model, a price sensitivity estimator, and an upgrade propensity scorer.

RAG can be used to surface relevant content in response to the user’s natural language input, while CAG can be used to refine this content based on domain-specific constraints, organizational context, and historical usage patterns. CAG is used to leverage predefined workflows, prior executions, and stored mappings to tailor module selection and pipeline structure, making results more precise and contextually actionable. For example, if the user input references a sports domain and a goal to improve retention, RAG might be used to retrieve general-purpose churn modules, but CAG would be used to prioritize fan engagement and loyalty models optimized for ticket renewals. Example-based learning that uses historical workflow patterns and successful module combinations may be used as templates to guide current recommendations and pipeline assembly decisions.

Unlike conventional applications of RAG limited to text generation, the MIO platform 106 described herein uses RAG and CAG together across multiple steps of the technique 300, including module selection, journey retrieval, workflow assembly, data routing, and even reasoning model configuration. The combination of RAG and CAG ensures that workflow outputs are linguistically relevant, technically executable, and contextually appropriate for the user’s specific domain and objectives. Thus, the use of RAG and CAG transforms natural language objectives into structured, executable configurations through a hybrid of knowledge retrieval and contextual inference.

The mapping 308 may be implemented as a stored structure (e.g., a file, a lookup table, or another suitable data structure, procedure, or set of steps) that encodes pre-established associations between user inputs (e.g., concepts or keywords or the like extracted therefrom by the language model), journeys, modules, and execution logic. A “journey” in this context refers to a predefined or learned mapping between specific types of user-defined objectives (e.g., improving subscription renewals, optimizing upsells) and corresponding module selections, sequences, or workflows. The mapping 308 may include elements such as: module dependency metadata, module-to-objective mappings, journey identifiers, workflow templates, historical module usage patterns, and known module compatibilities.

The mapping 308 is used in two distinct phases. First, as part of the RAG and CAG module recommendation process described in step 304, where it helps match natural language input to journeys and appropriate modules. Second, the mapping 308 is consulted again in step 314 to support construction of the final execution pipeline. The technique 300 uses the mapping 308 to ensure that identified and user-selected modules form a valid and coherent analytical sequence, consistent with historical best practices, dependency requirements, and user context. The mapping 308 thus serves as both a repository of domain knowledge and a coordination schema for constructing modular workflows in a reusable and explainable manner. This dual-phase utilization of the mapping 308 ensures consistency between initial module recommendations and final pipeline construction.

At step 312, the technique 300 receives (e.g., pulls, polls for, reads, etc.) data from one or more data sources, such as the data source 112 of FIG. 1. In some implementations, a data ingestion component may perform schema detection, format normalization, data validation, or preliminary data quality assessment tasks prior to pipeline execution. The data may include first-party customer interaction data, second-party data, third-party data (e.g., demographic or behavioral data), or transactional records that enable comprehensive analytical processing. As further described herein, the received data may be subjected to a goal-aware (or contextually aware) cleansing process that adapts cleansing logic based on the modules selected for execution.

The goal-aware cleansing process may include dynamic feature prioritization, context-specific imputation strategies, and adaptive data quality thresholds that align preprocessing operations with downstream module requirements. To illustrate, if a selected module is to predict price sensitivity, any missing income_band data may be more critical than missing zip_code data and imputation strategies can be prioritized accordingly.

At step 314, the technique 300 determines an execution pipeline by finalizing the operational order and configuration of the selected modules. Determining the execution pipeline includes ensuring valid data flows between modules, resolving any dependency constraints, and optimizing the sequence for computational efficiency. The technique 300 may apply logic based on dependency graphs, configured in the mapping 308, where certain analytical operations must precede others, compatibility requirements between module input and output schemas, and semantic scoring models that evaluate the appropriateness of module combinations. The execution pipeline determination may be dynamically configured based on user intent, specific module constraints, and established behavioral logic patterns across different industry domains.

At step 316, the selected modules are deployed into the execution environment. Deployment may involve loading containerized versions of the modules into a cloud-based runtime environment, initializing parallel execution frameworks, or allocating serverless computing resources to support the analytical workload. In some implementations, the technique 300 may optimize deployment for factors such as processing latency, computational cost (e.g., computational resource demands), or data locality by selecting appropriate edge computing nodes or regionally distributed processing centers. To illustrate, and as further described herein, the deployed modules may include standard ML algorithms such PCA or gradient boosting frameworks, as well as more complex multi-model analytical stacks that support reasoning-first architectural approaches.

At step 318, the technique 300 executes the pipeline by processing the user data through the configured sequence of modules. Pipeline execution may include data transformations, feature engineering and derivation, customer clustering, predictive modeling, and explainability analysis. In some implementations, the execution process is monitored in real-time with intermediate outputs logged for traceability, debugging, and performance optimization.

As further described herein, at least some of the modules may employ a reasoning-first architecture so that behavioral signals (e.g., customer loyalty indicators, engagement enthusiasm metrics, or price sensitivity scores) are derived through executive logic before statistical modeling operations, thereby improving model explainability and enhancing the utility of downstream analytical results by providing semantically meaningful features for machine learning algorithms. The reasoning-first architecture derives human-interpretable behavioral indicators using rule-based executive logic prior to applying statistical learning algorithms, ensuring that machine learning models operate on semantically meaningful features rather than raw data attributes.

Executing a module may involve applying pre-trained or dynamically configured ML algorithms, with optional fine-tuning or adaptation based on received data or preceding module outputs, data generated by one or more of the ML algorithms of the module, or a combination thereof.

At step 320, the technique 300 generates insights based on the results of the pipeline execution. Insight generation may include creating visualization dashboards, customer segment profiles, ranked predictive scores, or interpreted analytical summaries. In some implementations, RAG and CAG techniques are used at this stage to generate customized insight narratives and context-aware interpretations of the analytical results. The insights generated by the technique 300 may include one or more of (1) visual dashboards and graphical representations, (2) narrative summaries and textual explanations, (3) interpretive analysis with contextual recommendations, and (4) agent-powered interactive guidance for follow-up questions and strategic refinement.

The technique 300 may employ specialized AI agents, such as reporter AI agents for generating insights summaries, and expert AI agents for providing detailed explanations and responding to follow-up questions. These AI agents enable users to ask follow-up questions such as “Which customer segment is most likely to respond to a discount offer?” and receive explanations that integrate model attribution techniques, such as SHAP values, with executive logic reasoning. Executive logic reasoning refers to the derivation of semantically rich, business-relevant features (such as loyalty or price sensitivity) from raw data using domain-specific models (e.g., logistic regression, uplift modeling), prior to statistical analysis. The AI agents may be implemented as specialized language models fine-tuned for domain-specific explanation generation and interactive question answering.

At step 322, the technique 300 may optionally transmit an actionable plan based on the generated analytical outputs. In some implementations, actionable outputs refer to structured data deliverables that contain specific customer identifiers, behavioral scores, and recommended actions that can be directly implemented by marketing teams or automated systems without additional processing or interpretation. This may include exportable data files that may be in JSON, XML, or some other suitable format, and can include the audience identifiers, propensity scores, suggested marketing actions, and integration instructions for downstream systems 114 such as CDPs or CRM systems, or strategic recommendation checklists (e.g., prioritized action items for campaign execution) presented through the client 102 interface. In some implementations, transmission may occur via direct API integrations, downloadable datasets, scheduled data streaming, or automated report generation, such as to enable immediate campaign activation and customer engagement initiatives. The technique 300 may integrate with marketing automation platforms, audience targeting systems, or customer communication tools to enable direct activation of the analytical insights.

In some implementations, the technique 300 may include iterative feedback mechanisms where user interactions, output validations, and performance metrics are captured to continuously refine future module selection algorithms, pipeline design optimization, and data preprocessing logic. The feedback mechanisms can be used to enable continuous learning capabilities, and AI agents may remain available after initial output generation to assist with result clarification, insight refinement, or longitudinal analysis as business conditions evolve.

The technique 300 may include error handling and recovery mechanisms to address module execution failures, data quality issues, or pipeline interruptions. Error handling may involve automatic retry logic, fallback module substitution, or graceful degradation to simpler analytical approaches while maintaining workflow continuity.

FIG. 3B illustrates an example of a technique 350 for automated module recommendation and pipeline configuration by dynamically processing natural language inputs through coordinated recommendation and configuration engines within the MIO platform 106. The technique 350 illustrates an example of the internal architecture and data flow mechanisms that support the module identification and finalization processes described in steps 304 and 314 of FIG. 3A.

The technique 350 begins when user input 352 is received and processed by a language model 354, which interprets natural language objectives and extracts semantic features relevant to module selection. The language model 354 enables the MIO platform 106 to understand high-level business goals expressed in natural language, such as “increase subscription renewals” or “optimize pricing for season tickets,” without requiring users to specify technical implementation details.

The recommendation engine 360, which is a component of the MIO platform 106, receives processed input from the language model 354 and accesses the mapping 308 to identify potentially relevant modules. The mapping 308 contains or has access to a module registry 356 that stores metadata and descriptions of available analytical modules, and journeys 358 that represent predefined workflow templates mapping specific business objectives to optimized module sequences. The recommendation engine 360 implements RAG techniques to dynamically retrieve relevant modules and journey templates from the mapping 308 based on semantic similarity to the user's stated objectives. CAG can also be applied to refine these initial selections by incorporating domain-specific constraints, organizational context, and historical usage patterns stored in historical performance data 368. The recommendation engine 360 generates module recommendations 362 that represent a set of analytical components deemed most appropriate for addressing the user's specified challenge. These recommendations correspond to the identified modules presented to users in step 304 of FIG. 3A, enabling user selection and finalization of the analytical workflow components.

The configuration engine 364, also a component of the MIO platform 106, receives the finalized module recommendations 362 (or a subset thereof based on user selections) from the recommendation engine 360 and accesses both the mapping 308 and historical performance data 368 to determine an optimal execution sequence. The configuration engine 364 performs dependency graph analysis, modeling modules as nodes and data dependencies as edges to resolve execution order requirements, such as ensuring clustering operations precede prediction tasks. Semantic scoring techniques are applied to rank potential module sequences based on contextual relevance and historical performance metrics, resulting in the generation of a modular execution pipeline 366 of ordered modules that represents the structured analytical workflow ready for deployment and execution as described in steps 314 and 316 of FIG. 3A.

A feedback mechanism may capture performance metrics and user validations from the executed pipeline and updates the historical performance data 368, thereby enabling continuous improvement of both module recommendation accuracy and pipeline configuration optimization over time. This feedback loop ensures that the MIO platform 106 learns from previous executions and refines future recommendations based on demonstrated effectiveness and user satisfaction patterns.

To illustrate, when a user describes a challenge (e.g., “increase ticket upgrades among fans who attended <5 games”), the MIO platform 106 employs RAG (retrieval-augmented generation) to retrieve related use cases, metadata, and journeys from the database 110. The CAG engine then enriches selection based on vertical context, historical performance metrics, and additional parameters stored in the mapping 308. The recommendation engine 360 includes matching graphs, rules, and reinforcement-learning-driven heuristics to identify stacks of modules that maximize historical impact score for the specified situation.

The recommendation engine 360 implements a matching graph that maps user input intent to known problem templates, and problem templates to recommended module stacks. The recommendation engine 360 applies a hybrid of heuristics plus reinforcement learning to prioritize modules with the highest historical impact score for that situation. When selected modules depend on inputs from other modules (e.g., a pricing module requiring cluster assignments), the configuration engine 364 implements dependency resolution to automatically include upstream components and construct a complete execution graph. The configuration engine 364 recursively assembles all required submodules and orchestrates them via a dynamic graph execution engine.

The following examples illustrate how the RAG and CAG engines process user inputs to generate module recommendations. When a user submits input such as “Marketing goal: Increase season ticket upgrades among fans who have attended less than 5 games this season,” the language model 108 executes an internal RAG query to retrieve past module stacks used for fan upgrade prediction in sports contexts with low-attendance segments. The RAG response from the database 110 indicates that based on prior campaigns, modules such as FanPropensityAI, PriceSensitivityAI, and SegmentReceptivityMapper should be considered, as these have shown greater than 22% lift in low-frequency attendance upgrade scenarios.

Building on the RAG result, the CAG engine processes additional context from the mapping 308, such as identifying that the user is a baseball team with a goal to improve upgrades during the last 2 weeks of the season. The CAG enhancement filters retrieved module recommendations to emphasize those optimized for urgency or late-season behavioral conversion, prioritizing modules with known responsiveness to short promotion windows. The final CAG and RAG recommendation generated by the recommendation engine 360 recommends LastMinute360, FanPropensityAI, and PromoOptimizerAI as an integrated stack, with justification based on high urgency, low attendance fans, and late-season opportunity window detection.

In another scenario, when a user provides the prompt “We want to drive a last-minute push for partial season ticket upgrades. Our promo offer is a 10% discount for fans who attended less than 3 games,” the MIO platform 106 processes this through both engines. The RAG component retrieves prior campaigns with similar partial package upgrades, best performing ML module combinations, and metrics such as conversion rate lift per segment. The CAG component identifies this is a sports team during end-of-season, flags urgency and discount-driven behaviors, and re-ranks modules that support discount sensitivity and rapid targeting. The combined output recommendation generated by the configuration engine 364 suggests a module stack including SegmentDifferentiator, PriceSensitivityAI, FanPropensityAI, and LastMinute360 to address the specific campaign requirements.

The dynamic module selection process implements a four-stage methodology where user input ingestion processes natural language challenges through RAG to retrieve relevant use cases and module metadata. Context-augmented guidance then enriches decisions by incorporating industry vertical, past model performance metrics, and user feedback patterns. The matching engine employs a hybrid of heuristics and reinforcement learning to prioritize modules with highest historical impact scores, followed by dependency resolution that recursively assembles required submodules through dynamic graph execution.

FIG. 3C illustrates an example of module registry entries 380 within the mapping 308 of FIG. 3A. The module registry entries 380 represent an excerpt of a larger registry, not an exhaustive listing of all available modules. The mapping 308 comprises a structured data repository that stores module metadata, dependency relationships, and industry-specific configurations to support automated module selection and pipeline assembly by the MIO platform 106. The mapping 308 can be organized in a tabular format that includes columns 382 through 392 that define characteristics of each analytical module within the module library 306.

The column 382 contains the module name, providing unique identifiers for analytical components. The column 384 specifies the purpose, describing the primary analytical objective or business function that each module addresses. The column 386 defines the inputs required for module execution, specifying the data types and formats needed for processing. The column 388 identifies the outputs generated by each module, defining the analytical products delivered upon completion.

Column 390 specifies dependencies, which identifies prerequisite modules or data processing steps that must be completed before a particular module can execute. The configuration engine 364 uses the dependency information in the column 390 to perform dependency graph analysis during pipeline assembly. For example, the FanPropensityAI module lists SegmentDifferentiator as a dependency, indicating that audience segmentation must occur before propensity scoring can be performed. Similarly, the UpgradeReceptivityAI module depends on LoyaltyScorer, requiring loyalty analysis to precede conversion probability calculations. When a user selects modules for execution, the configuration engine 364 automatically examines the Dependencies column 390 to identify and include all prerequisite modules, ensuring that the final execution pipeline maintains valid data flows and satisfies all module requirements.

The column 392 indicates the industries (e.g., domains or contexts) for which each module has been optimized, supporting context-augmented guidance during module selection. The structured organization of module metadata enables the MIO platform 106 to perform semantic matching between user objectives and available analytical capabilities, facilitating automated workflow assembly that resolves complex dependency chains and aligns technical resources with business requirements.

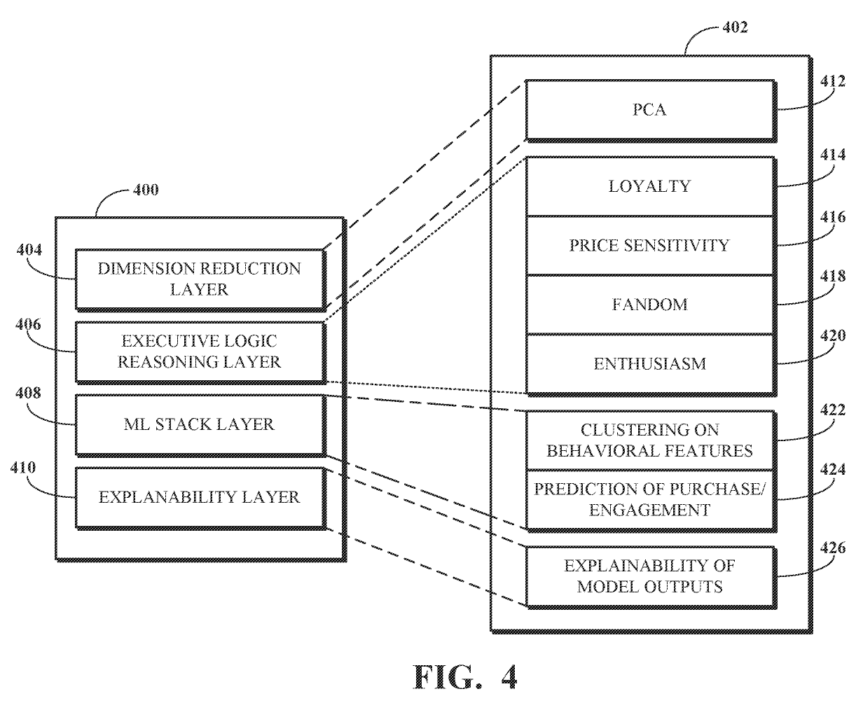

FIG. 4 illustrates an internal structure 400 of a composable module of the module library 306 of FIG. 3A. The internal structure 400 represents a general modular architecture pattern that enables flexible composition of analytical components across different problem domains within the module library 306. The internal structure 400 comprises a plurality of processing layers arranged in a sequential pipeline architecture, where each layer performs distinct analytical functions and passes processed data to subsequent layers.

The internal structure 400 includes a feature reduction layer 404, an executive logic reasoning layer 406, an ML stack layer 408, and an explainability layer 410. Each layer implements specific algorithmic components and serves a defined purpose within the overall analytical pipeline. Some modules may not include or implement some of these layers. The internal structure 400 demonstrates the composable nature of modules, enabling modules to integrate with other modules in the library 306. This modular design facilitates the creation of complex analytical workflows that can be dynamically assembled by the MIO platform 106 to deliver context-specific insights based on user-defined objectives. The modular architecture implemented across the module library 306 enables each selected module to implement a stack of algorithmic components that can be configured and sequenced according to analytical requirements.

The feature reduction layer 404 receives input data and performs dimensionality reduction operations to simplify high-dimensional datasets while preserving relevant variance and signal characteristics. The feature reduction layer 404 may implement various dimensionality reduction algorithms including PCA, t-SNE, autoencoders, independent component analysis (ICA), or feature selection algorithms to reduce noise and extract meaningful signals including behavioral density and attendance frequency patterns.

The executive logic reasoning layer 406 processes the dimensionally reduced data to derive semantically meaningful features through domain-specific analytical logic according to the design or purpose of the particular module. The executive logic reasoning layer 406 transforms raw data attributes into behaviorally interpretable features that align with analytical objectives. The executive logic reasoning layer 406 may implement rule-based reasoning engines, probabilistic models, neural network architectures, hybrid logic systems , logistic regression, gradient boosting, or transformer encoders to extract high-level semantic features and human-intuitive traits including loyalty, enthusiasm, and discount reactivity from processed input data patterns.

The ML stack layer 408 applies statistical and machine learning techniques to the semantically enriched features generated by the executive logic reasoning layer 406. The ML stack layer 408 may implement clustering algorithms such as such as KMeans, DBSCAN, or hierarchical clustering to group audiences into meaningful segments, classification models, regression techniques, ensemble methods, deep learning architectures, or custom-designed algorithms to identify patterns and generate predictions, or perform analytical tasks. The ML stack layer 408 applies predictive models such as XGBoost or ensemble methods to compute engagement or conversion propensities for each identified segment.

The explainability layer 410 generates interpretable explanations and attributions for the outputs produced by the ML stack layer 408. The explainability layer 410 may implement explainable artificial intelligence techniques including SHAP, LIME, attention mechanisms, or feature importance algorithms to ensure that analytical outputs include traceable justifications and interpretable reasoning pathways. The explainability layer 410 generates SHAP values to surface drivers behind each prediction and contextualizes output based on marketing objective, segment granularity, and platform integration target such as customer data platforms or customer relationship management systems.

The module 402 shows a specific implementation of the internal structure 400. A module (e.g., the module 402) serves as a self-contained analytical unit designed to process data and deliver actionable insights. The module 402 demonstrates how the generic layer architecture (e.g., the internal structure 400) is instantiated with specific algorithmic components for particular analytical objectives.

In the module 402 implementation, the feature reduction layer 404 is implemented as component 412, which applies PCA to perform dimensionality reduction on input data while preserving variance. The executive logic reasoning layer 406 is implemented as components 414, 416, 418, and 420, which derive semantically rich features through specialized analytical logic: the component 414 derives loyalty features from attendance and timing data using logistic regression models; the component 416 estimates price sensitivity from discount response patterns using uplift modeling techniques; the component 418 extracts fandom characteristics from social tags and merchandise data using latent embedding models; and the component 420 assesses enthusiasm levels from session behavior data using gradient boosting or long short-term memory (LSTM) neural networks.

The executive logic reasoning layer 406 implements embedded models such as logistic regression, XGBoost, LSTM, and transformers to derive semantic constructs such as loyalty, fandom, enthusiasm, and price sensitivity by generating semantic features including loyalty scores, fandom classifications, and enthusiasm vectors. This layer comprises a core component that performs semantic interpretation of raw behavioral data using pretrained machine learning models, rules, and decision logic to generate engineered features that reveal higher-level marketing signals. The executive logic reasoning layer 406 mimics human executive reasoning by interpreting why users behave in certain ways and what that means, rather than merely describing what users did.

For example, instead of simply noting that a user opened an email, the layer interprets that this user is likely price-sensitive and loyal, showing latent conversion potential. Unlike traditional pipelines that feed raw or transformed data directly into predictive models, the executive logic reasoning layer introduces a reasoning-first architecture (i.e., a pre-predictive layer) that extracts semantic meaning using learned behavioral models.

In the module 402 implementation, the executive logic reasoning layer 406 comprises components 414, 416, 418, and 420, each implementing specific embedded models to generate engineered features. Component 414 derives loyalty features from attendance and timing data using logistic regression models, processing raw inputs such as “attended 10 of last 12 home games, bought full-price tickets 7 times, last purchase 2 weeks ago, total spend $1,200” to generate, for example, loyalty_score = 0.87 derived from purchase recency and frequency. The component 416 estimates price sensitivity from discount response patterns using uplift modeling techniques, outputting, for example, price_elasticity = -1.2 inferred from uplift modeling across different price tiers. The component 418 extracts fandom characteristics from social tags and merchandise data using latent embedding models, generating, for example, fandom_cluster = “Social-first Superfan” using embeddings from tagged content. The component 420 assesses enthusiasm levels from session behavior data using, for example, gradient boosting or LSTM neural networks, producing, for example, enthusiasm_vector = [0.5, 0.3, 0.8] that captures session decay behavior over time.

The executive logic reasoning layer 406 employs construct-to-model mappings, which define the specific machine learning algorithms used to derive each behavioral construct from raw data inputs. These construct-to-model mappings employed by the executive logic reasoning layer 406 include loyalty analysis using logistic regression or decision trees based on recency, frequency, and spend patterns, price sensitivity estimation using uplift models or gradient boosting based on response to past discounts and variance in buying across price tiers, enthusiasm assessment using LSTM or gradient boosting based on scroll velocity, time on page, and email sequence engagement, and fandom classification using embedding models or cluster tags based on merchandise behavior, social tags, and repeat usage of fan-related terminology. These engineered features are passed to downstream clustering or predictive models, improving both segmentation accuracy and interpretability.

The ML stack layer 408 is implemented as components 422 and 424, which apply statistical modeling techniques to the processed features: the component 422 performs KMeans clustering on the behavioral features to identify distinct segments, and the component 424 applies XGBoost algorithms to predict purchase likelihood or engagement probability. The explainability layer 410 is implemented as component 426, which employs SHAP techniques to generate interpretable explanations for the analytical outputs.

Data flows through the module 402 in a sequential manner, where outputs from each layer serve as inputs to subsequent layers. To illustrate the reasoning-first architecture, data flows sequentially from input through PCA dimensionality reduction (component 412), then through reasoning models for semantic feature derivation (components 414, 416, 418, 420), followed by KMeans clustering (component 422), XGBoost predictive modeling (component 424), and SHAP explainability analysis (component 426) to generate the final output, thereby ensuring that semantically rich features are derived prior to clustering or prediction operations. Certain of the components of the executive logic reasoning layer 406 and/or the ML stack layer 408 may proceed (e.g., operate) in parallel. The reasoning-first architecture of modules enables the MIO platform 106 to extract semantically rich features before applying statistical modeling, improving interpretability and alignment with domain-specific objectives. The module 402 may include error handling and validation mechanisms at each layer to ensure data quality and processing reliability, including input validation, intermediate result checking, and graceful degradation capabilities when data quality issues are detected.

The module 402 includes standardized input/output interfaces that enable seamless integration with other modules in the library 306, supporting complex pipeline assembly where outputs from one module serve as inputs to downstream analytical components. Alternative implementations of the module 402 may include parallel processing capabilities for handling large datasets, streaming data processing for real-time applications, or configurable layer architectures that allow dynamic selection of algorithms based on data characteristics and computational constraints.

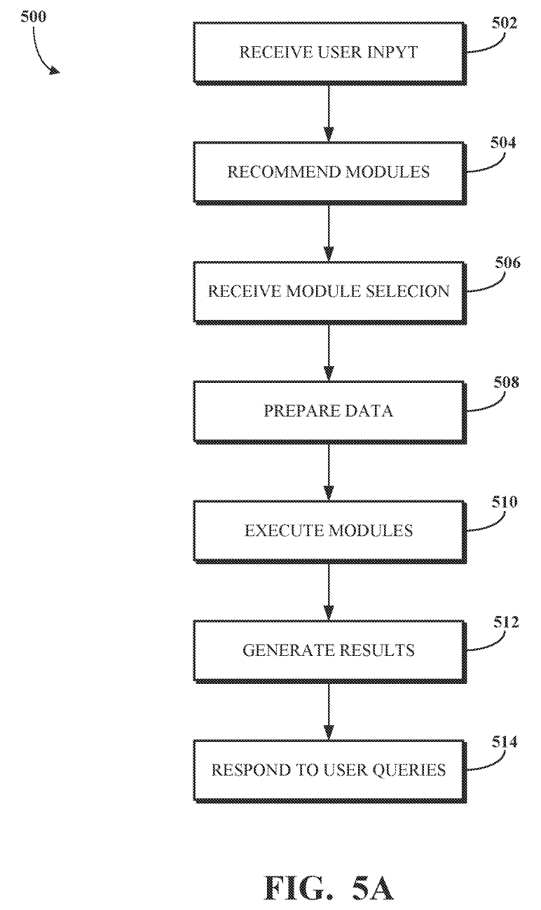

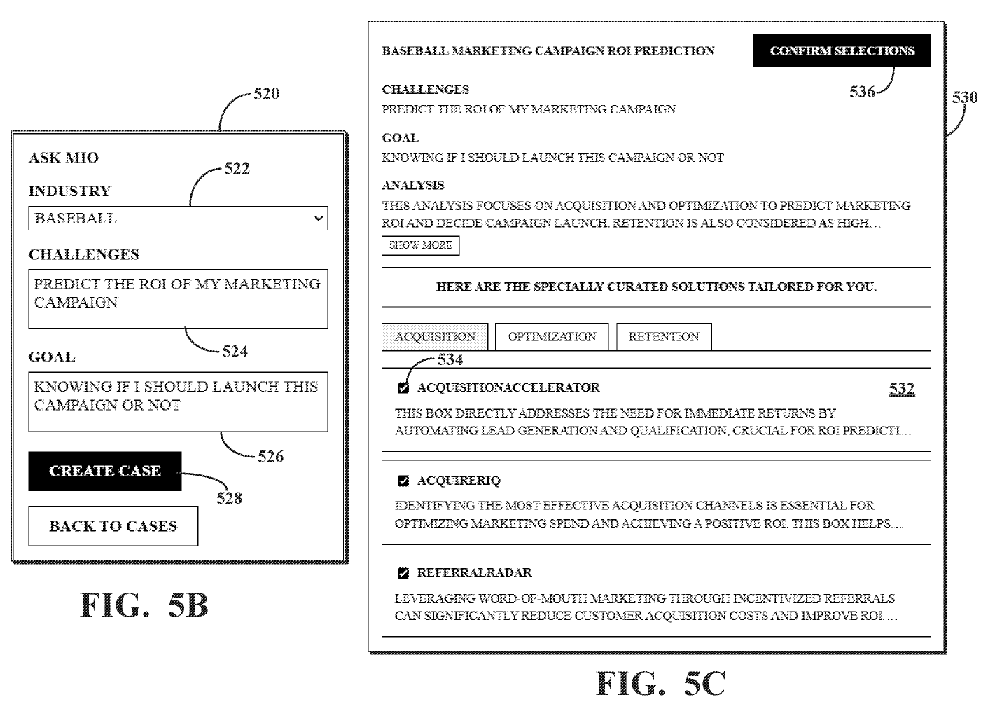

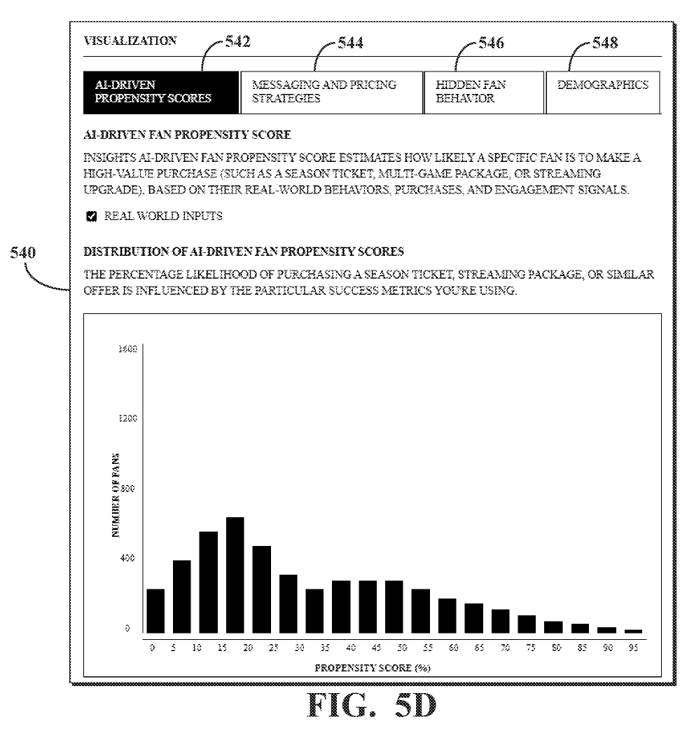

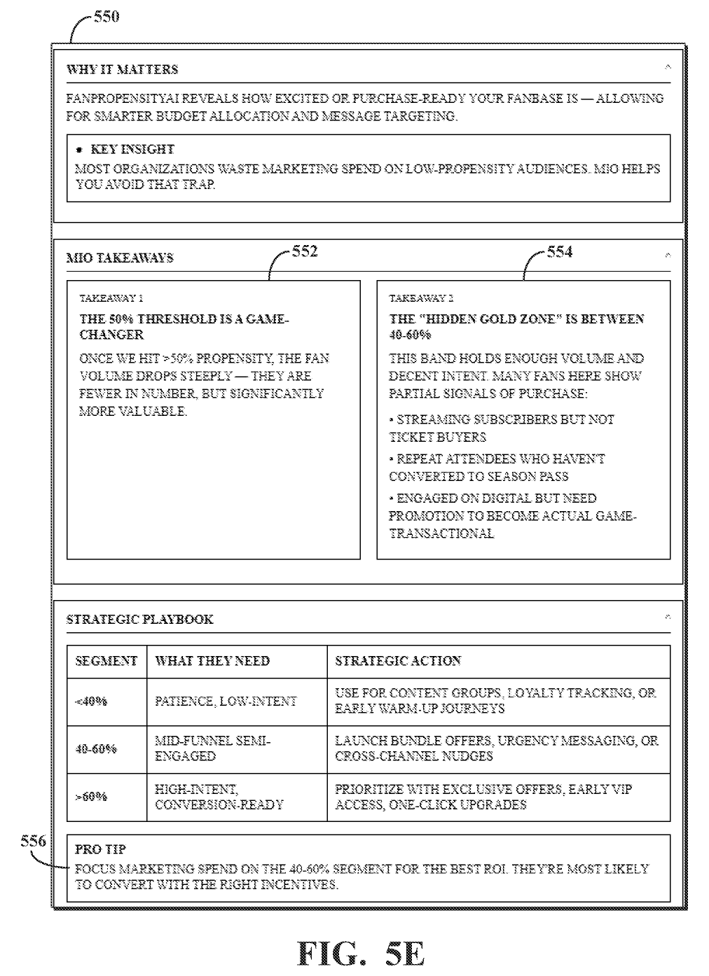

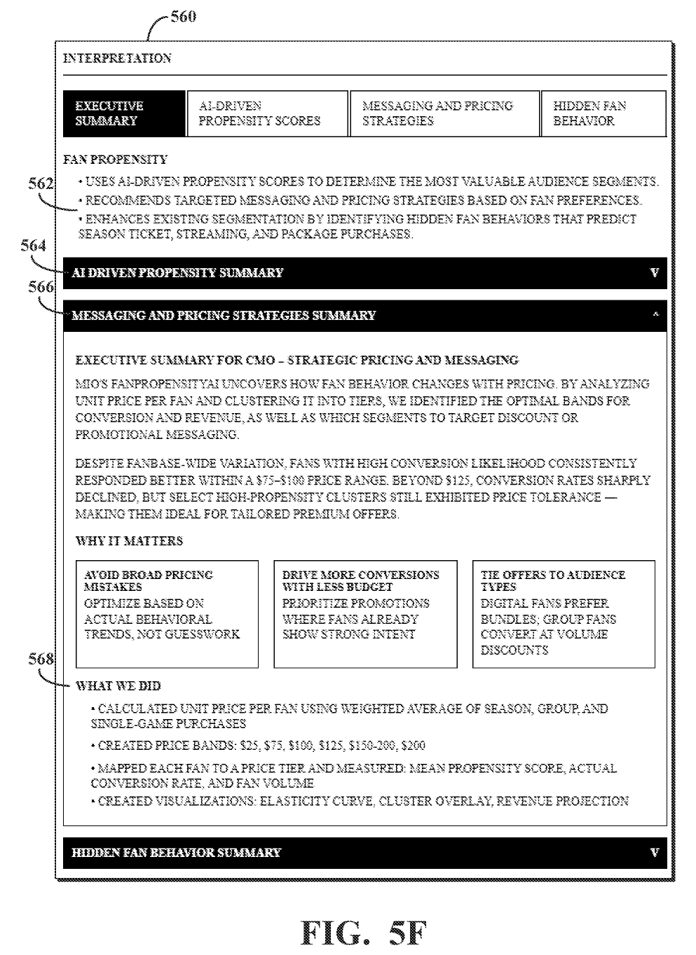

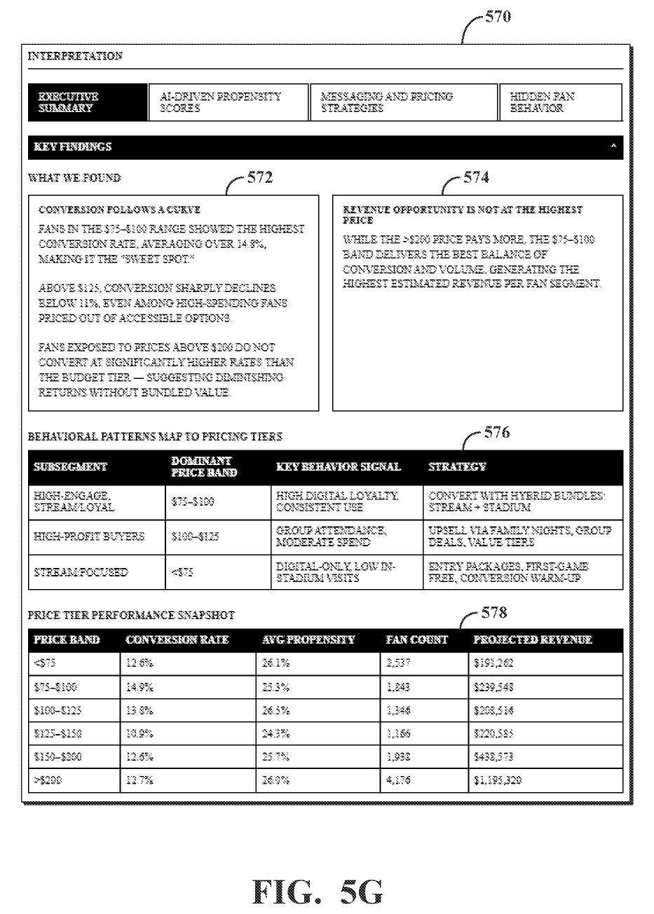

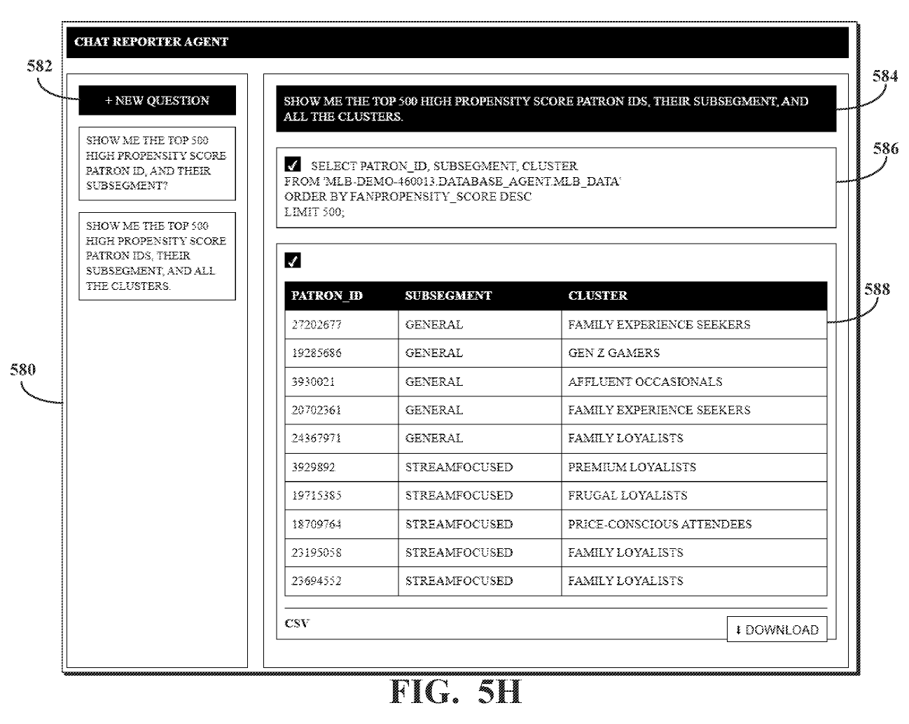

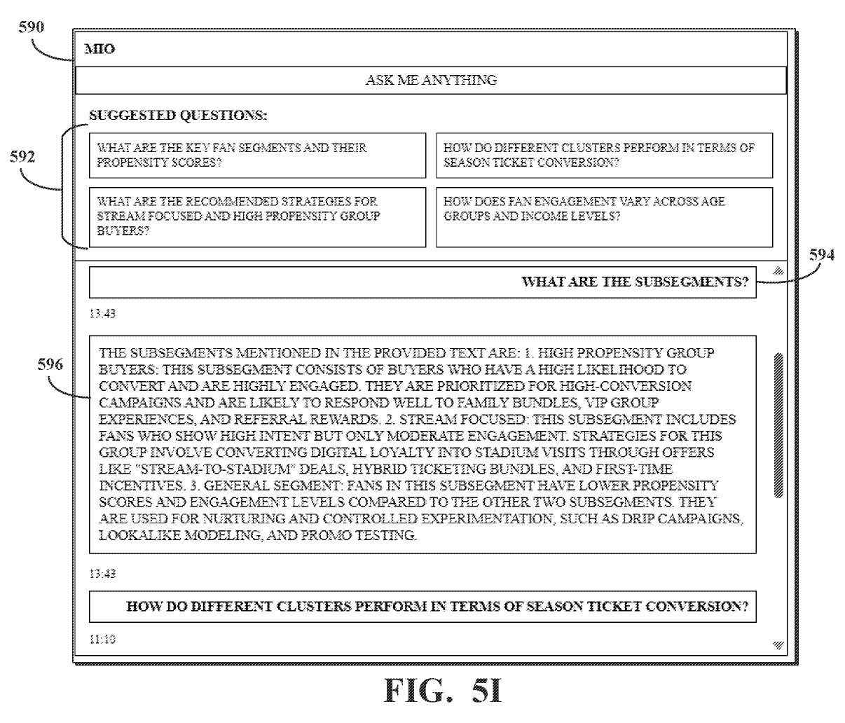

FIG. 5A illustrates an example of a technique 500 for transforming a user-defined marketing challenge into actionable insights using the modular AI-driven system described in FIGS. 1 through 4. The technique 500 depicts an end-to-end workflow from user input to actionable results by transforming natural language objectives into data-driven outcomes through the MIO platform 106. The technique 500 can be implemented by the MIO platform 106 and corresponds to a workflow aligned with addressing a specific challenge (e.g., a marketing challenge) for a professional sports team. The technique 500 is further explained with reference to FIGS. 5B through 5I.

The technique 500 generates of comprehensive insights through four distinct output formats that enable users to analyze, interpret, and activate analytical results across different organizational functions. Visual dashboard tabs present propensity metrics, pricing analysis, hidden behavioral patterns, and demographic insights through interactive interfaces that allow users to explore segmentation results and predictive scores, as illustrated in FIGS. 5D through 5G. Interpretive summaries provide auto-generated insights with strategic callouts that translate complex analytical outputs into accessible business recommendations, as demonstrated in FIGS. 5E through 5G.

SQL or API-ready exports enable seamless integration with downstream systems including customer data platforms, email automation systems, and call center management platforms, with the Reporter Agent automatically generating structured queries and datasets as shown in FIG. 5H. Executive recommendations provide strategic guidance and specific action items such as “Push premium offers to Segment C with 15% discount,” delivered through the Expert Agent's analysis of module outputs and strategic knowledge retrieval as illustrated in FIG. 5I. This multi-format approach ensures that analytical insights can be consumed and acted upon by different stakeholders within an organization, from data analysts requiring detailed exports to executives needing strategic recommendations.

At step 502, the technique 500 receives user input. FIG. 5B illustrates an example of a user interface 520 via which the user can provide input. In this case, the user input specifies a marketing challenge or objective. In this example use case, a marketer from a sports team enters a natural language challenge or goal via the client 102 of FIG. 1. As shown in FIG. 5B, the interface includes an industry selection field 522, a challenges text field 524, and a goal text field 526. The user can then initiate the workflow by invoking a control 528 (e.g., an action button), which causes the input to be submitted to the MIO platform 106 for processing using retrieval-augmented generation techniques as described in connection with FIG. 3A.

At step 504, the technique 500 recommends modules from the module library 306 based on the received user input. As already described, the MIO platform 106 may implement a recommendation engine that utilizes RAG and, optionally, CAG, to suggest a set of pre-built machine learning modules from the module library 306. RAG retrieves potential module candidates based on user language and past use cases, while CAG narrows the candidates using domain knowledge and prior execution patterns to identify relevant analytical modules suited to the specific domain (e.g., sports marketing domain) and, in this case, the specific attendance-related objective.

FIG. 5C illustrates a user interface 530 of recommended modules. The user interface 530 includes the list of the recommended (e.g., identified) modules and a description for each, such as description 532. The module descriptions may provide detailed explanations of the modules’ purposes and functionalities. Using controls (e.g., a control 534), the user can select modules of interest. Then the user invokes control 536 to cause the technique 500 to proceed to the data preparation step with the selected modules. As such, at step 506, the technique 500 receives module selection confirmation from the user.

At step 508, the technique prepares data by implementing goal-aware data preparation procedures tailored to the selected modules’ requirements. While not specifically shown in FIG. 5A, the user may be prompted to provide the data (or a data source from which the data is to be obtained) with respect to which the selected modules will perform their analysis and generate marketing insights. That is, the technique 500 may initiate data collection by requesting the user to provide first-party data, offering options to either upload the data directly or grant access to existing remote storage. This may include ingesting first-party, second-party, or third-party datasets, performing schema alignment, and applying cleansing and transformation logic appropriate for the selected modules.

In the particular illustrated scenario, the user may submit first-party data, such as ticket purchase history, sales records, customer profiles, and engagement metrics, through direct uploads in structured formats or by providing access to remote data storage systems, with the system securely storing the data using encryption and metadata tagging for identification and compliance.

The goal-aware cleansing process adapts preprocessing to the selected modules’ requirements or implementation, prioritizing relevant features like attendance frequency. The system then cleans the submitted first-party data through a hybrid process, where AI tools perform initial tasks such as outlier detection and missing value imputation, followed by human validation to address complex, domain-specific anomalies, thereby resulting in high-quality, optimized data for accurate analysis.

At step 510, the technique 500 executes the selected modules by processing the prepared data through the selected analytical components according to a determined execution pipeline. The workflow determination process involves the MIO platform 106 utilizing the mapping 308 (as described in connection with FIG. 3A) to analyze the selected modules and their interdependencies to establish an optimal execution sequence. The mapping 308 defines the relationships between modules, data flow requirements, and execution dependencies, enabling the system to construct a directed acyclic graph (DAG) that defines the execution order.

The execution pipeline represents the physical implementation of this workflow as determined based on the mapping 308, where each module in the sequence processes data and passes results to subsequent modules according to the predefined relationships.

At step 512, the technique generates results by consolidating outputs from the executed modules into comprehensive insights. The technique 500 generates diverse types of outputs. In some implementations, the technique 500 generates three types of outputs from the module execution: textual summaries created by the language model 108 for non-technical understanding, visual representations suggested by the AI and rendered using appropriate tools, and enriched datasets with new dimensions and metrics for further analysis, all integrated into a comprehensive report.

To illustrate, in the particular scenario illustrated here, the generated results may include predictive scores, visual dashboards with fan segment profiles, segmentations, narrative explanations, and activation-ready datasets for downstream systems like CRMs. For textual summaries, the technique 500 may generate anonymized data and may generate prompts to generate user-friendly narratives; for visualizations, the technique 500 may suggest chart types, which are rendered using visualization tools, mapping data to appropriate formats; for enriched datasets, new metrics may be merged with the original data using data processing libraries, formatted for download in structured formats. The technique 500 delivers these results through the client 102 interface, with AI agents providing additional interpretive guidance. As such, the step 512 can be said to translate the analysis (e.g., the execution of the selected modules) into user-friendly (e.g., marketer-friendly) insights.

FIGS. 5D, 5E, 5F, and 5G are examples of user interfaces that illustrate results generated by the technique 500. FIG. 5D is an example of a user interface 540 that illustrates the visualization and interpretation dashboard generated by the technique 500. The user interface 540 presents the analysis results through a tabbed interface structure that organizes insights into actionable categories for marketing decision-making. As shown, the interface includes four tabs: a first tab 542 for propensity-based metrics, a second tab 544 for pricing sensitivity and messaging strategy, a third tab 546 for hidden behavioral patterns, and a fourth tab 548 for demographic insights. To illustrate, the output insights may be mapped into four chief marketing officer (CMO)-facing tabs: Propensity Scores, Pricing Sensitivity & Messaging, Hidden Behavioral Clusters, and Demographic Segment Views.

The first tab 542 presents propensity-based metrics derived from the executed modules, including conversion probability scores, engagement forecasts, and loyalty likelihood measurements that enable precise targeting decisions. The second tab 544 highlights pricing sensitivity analysis and messaging strategy recommendations, displaying optimal pricing points using inferred price elasticity signals and customized messaging profiles aligned with audience segment characteristics. The third tab 546 reveals hidden behavioral patterns discovered through the clustering and reasoning components of the selected modules, surfacing latent traits, micro-behaviors, and overlooked patterns that inform strategic decisions. The fourth tab 548 provides demographic breakdowns of the analyzed audience, including composition by age, gender, location, and other relevant variables that support targeting alignment and segment validation.

FIG. 5E illustrates an example of a user interface 550 generated by the technique 500 of FIG. 5A. The user interface 550 illustrates user-friendly insights generated by the technique 500 at step 512. As shown, the technique 500 produces insights such as insights 552, 554, and 556 that translate the statistical analyses performed by the executed modules into accessible, actionable recommendations. These insights can be generated using the language model 108, which processes the computational outputs from the selected modules and converts them into narrative explanations, strategic recommendations, and practical guidance suitable for non-technical users.

The natural language summaries and strategic recommendations are generated by AI agents leveraging case-based retrieval mechanisms that access historical analytical patterns and problem-strategy mappings stored in the database 110. The AI agents employ RAG techniques to identify similar analytical scenarios from previous executions and apply contextual reasoning (e.g., CAG) to adapt successful strategy templates to the current user objectives, thereby ensuring that the generated recommendations are grounded in proven analytical workflows and domain-specific best practices rather than generic language model outputs. As used herein, a “strategy template” refers to business guidance frameworks authored by domain experts that provide specific marketing recommendations, pricing strategies, and tactical implementations based on analytical results. Strategy templates translate module outputs into actionable business instructions such as “recommend 48-hour discounts for Theme Night offers” or “prioritize urgency-based messaging for price-sensitive segments.”

FIG. 5F illustrates an example of a user interface 560 generated by the technique 500 showing an interpretation dashboard with expandable content sections. The user interface 560 displays insights organized through a tabbed interface structure. As shown, the user interface 560 includes a Fan Propensity section 562 that provides a high-level overview of the module’s capabilities and segmentation approach. The user interface 560 includes expandable sections, including a section 564 (AI Driven Propensity Summary) shown in collapsed state, and a section 566 (Messaging and Pricing Strategies Summary) shown in expanded state. The section 566 contains detailed analytical outputs generated by the language model 108, including executive summaries, strategic interpretations organized in structured layouts, and methodological transparency information. A “What We Did” subsection 568 provides accessible technical details about the analytical processes performed by the executed modules.

FIG. 5G illustrates an example of a user interface 570 generated by the technique 500 showing detailed analytical findings within the interpretation dashboard. The user interface 570 displays the “Key Findings” section, presenting comprehensive insights derived from the executed modules. As shown, the interface includes a “What We Found” section containing two primary findings: a conversion analysis panel 572 and a revenue optimization panel 574.

The conversion analysis panel 572 presents insights regarding conversion rate patterns across different price ranges, identifying optimal pricing tiers based on fan behavior analysis. The revenue optimization panel 574 highlights revenue opportunity findings, demonstrating how pricing strategy impacts overall revenue generation rather than simply maximizing individual transaction values.

The user interface 570 further includes a behavioral patterns mapping table 576 that correlates fan subsegments with their dominant price bands, key behavioral signals, and recommended strategic actions. This table enables targeted marketing approaches based on identified behavioral characteristics. Additionally, a price tier performance table 578 provides quantitative metrics including conversion rates, average propensity scores, fan counts, and projected revenue across different price bands, enabling data-driven pricing decisions.

These analytical outputs demonstrate how the language model 108 processes the computational results from the executed modules to generate structured, actionable insights that translate complex statistical analyses into practical business intelligence for marketing strategy optimization.

Referring again to FIG. 5A, at step 514, the technique 500 responds to user queries. The technique 500 enables the user to ask follow-up questions, request clarifications, or seek additional strategic guidance based on the analytical findings. The MIO platform 106 may implement one or more AI-based agents that enable interactive exploration of the generated results. The user may pose additional natural-language questions such as “Why was this segment chosen?” or “What action should be taken next?” These queries are processed using a reporter AI agent and an expert AI agent, which draw from module outputs, semantic features, and model attribution layers (e.g., SHAP).

The technique 500 may further collect user feedback on the module recommendations and generated outputs through user interfaces associated with the MIO platform 106 and uses the feedback to validate and iteratively refine the language model and recommendation process. The technique 500 may monitor improvements in accuracy over time. A feedback mechanism captures user ratings and comments, storing them for analysis, with fine-tuning processes applied to the language model 108 based on collected data, and performance metrics tracked to ensure continuous improvement.

The interactive query interface and agent-powered responses are illustrated in FIGS. 5H and 5I. FIG. 5H illustrates an example of a user interface 580 demonstrating the Reporter AI agent functionality within the MIO platform 106. The user interface 580 illustrates how users can interact with the MIO platform 106 through natural language queries to extract specific data and generate actionable reports.

Via a control 582, the user can generate a new query, such as a query shown in a chat-based interaction panel 584 where users can input natural language queries. A Reporter Agent of the MIO platform 106 processes the natural language input. In the illustrated scenario, the Reporter Agent automatically generates a structured SQL query, as shown in the query generation section 586. Accordingly, business-oriented requests are translated into executable database queries without requiring technical expertise from the user. The results are presented in a structured data table 588 displaying the requested information in an organized format with columns.

FIG. 5I illustrates an example of a user interface 590 demonstrating expert AI agent functionality within the MIO platform 106. The user interface 590 illustrates how users can interact with the MIO platform 106 through conversational queries to receive strategic recommendations and detailed analytical insights. A section 592 presents pre-configured queries, which are generated based on the selected modules. In an example, a module may be associated with pre-configured queries that can be presented to the user. However, the user can enter queries that are not pre-configured. The user interface 590 illustrates that, in response to the user entering or selecting a pre-configured query 594, the MIO platform 106 generates a response 596.

The MIO platform 106 generates responses to user queries through a multi-stage process that may use both the executed module outputs and retrieval-augmented generation techniques. When a user submits a query, the MIO platform 106 may first access the knowledge base that has been populated with machine learning outcomes from the previously executed modules, including derived behavioral features, clustering results, predictive scores, and explainability data. RAG may then be employed to retrieve relevant analytical content from this module-generated knowledge base, and applies CAG to refine the response based on the user’s industry context, selected modules, and specific analytical objectives. Accordingly, the generated responses are not generic AI-generated text, but rather are grounded in the actual analytical results produced by the domain-specific machine learning modules, enabling the Expert Agent to provide strategically relevant recommendations and insights that are directly tied to the user’s data and selected analytical workflow.

The following describes the technical implementation and enhanced functionality of the Expert Agent and Reporter Agent within the MIO platform 106. The Expert Agent interprets module output and generates business-level recommendations by combining the results of RAG, which retrieves relevant past strategies and case snippets from the database 110, with CAG, which injects contextual information based on the user's domain, time horizon, and urgency from the mapping 308. For example, when a sports team attempts to boost last-minute upgrades, the Expert Agent may recommend a stack including FanPropensityAI, LastMinute360, and PromoOptimizerAI, then generate the recommendation that fans in this segment respond to urgency framing and should receive 48-hour discounts for Theme Night offers, similar to Campaign X in 2024.

The Expert Agent executes a three-step process that begins with RAG retrieval of playbooks, examples, pricing templates, and outcome records from the human-curated strategy corpus stored in the database 110. The CAG component then filters and re-ranks these retrieved elements based on context, timing, urgency, and segment structure information from the mapping 308. Finally, the generation phase composes actionable output by blending real module results with contextual prompts and strategy templates to produce recommendations tailored to the user's specific situation and industry context.

The Reporter Agent automatically translates business-oriented natural language requests into executable database queries without requiring technical expertise from users. When users submit queries such as “Show me high-value fans who haven't purchased in 30 days,” the Reporter Agent generates structured SQL queries and presents results in organized data tables that enable immediate analysis and decision-making. This capability eliminates the need for users to possess database query skills while maintaining access to detailed analytical outputs.

The technical differentiation of the MIO platform 106 lies in its approach to strategic knowledge management and application. The strategic knowledge employed by the Expert Agent is not scraped or passively learned from general sources, but is deliberately authored by domain experts and stored in the database 110 as a curated corpus of proven strategies. The RAG engine prioritizes proven, context-aware strategies rather than general internet text or unverified heuristics, ensuring that recommendations are grounded in real-world experience and demonstrated results. The MIO platform 106 transforms real human expertise into structured machine-readable prompts, effectively blending artificial intelligence capabilities with high-quality decision logic derived from marketing professionals and data scientists with direct industry experience.

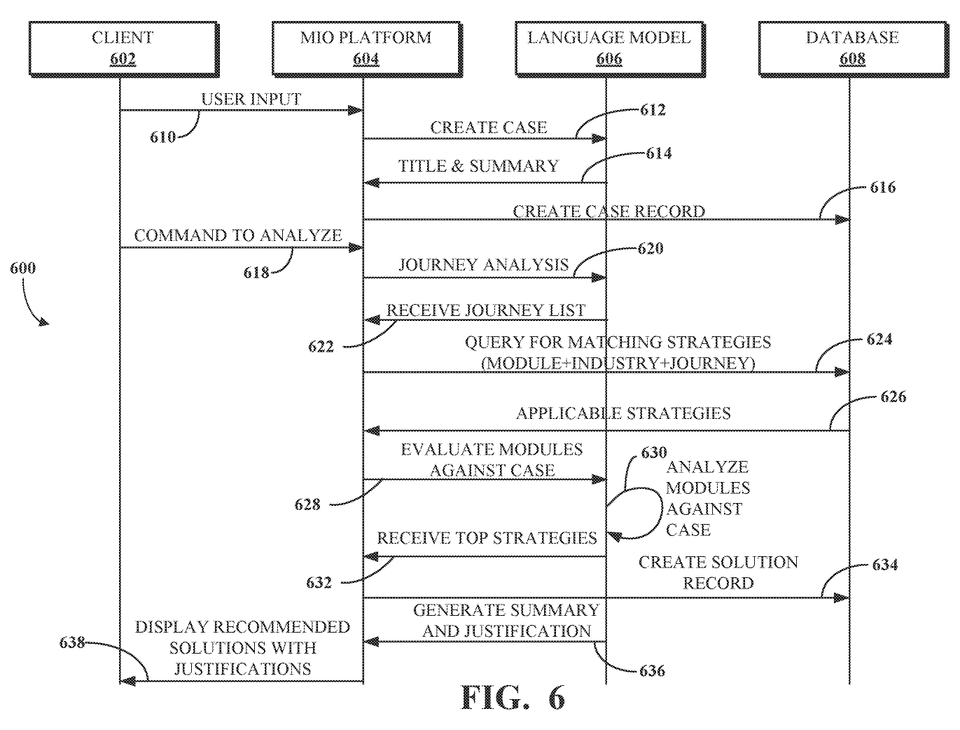

FIG. 6 illustrates an interaction diagram 600 for the automated module recommendation and journey analysis process within the MIO platform. The interaction diagram is shown as including a client 602, an MIO platform 604, a language model 606, and a database 608, which can be, respectively, the client 102, the MIO platform 106, the language model 108, and the database 110 described in connection with FIG. 1. The interaction diagram 600 depicts the technical workflow by which natural language user inputs are transformed into structured module recommendations through a series of coordinated interactions between these system components.

The interactions with the language model 606 are conducted via prompting, which refers to the process of providing structured textual inputs to a language model to elicit specific types of responses or analyses. In some implementations, prompts may include contextual information, examples, and specific instructions that guide the language model to generate responses aligned with the system’s analytical objectives. The prompting mechanism enables the MIO platform 604 to leverage the language model’s natural language processing capabilities while maintaining control over the output format and content relevance.

At step 610, the MIO platform 604 receives user input from the client 602, which may include industry specifications, marketing challenges, and business objectives expressed in natural language. This user input corresponds to the natural language interface described in the detailed description, where marketers can specify goals such as “increase subscription renewals” or “optimize pricing for season tickets” without requiring technical expertise in machine learning configuration.

At step 612, the MIO platform 604 creates a case (e.g., an object or other data structure representing the session between the user and the MIO platform 604) based on the user input by structuring the received information into a standardized format suitable for analysis. In some implementations, this case creation process may involve parsing the natural language input to extract key entities, objectives, and contextual information that will inform subsequent module selection decisions.

At step 614, the MIO platform 604 receives a title and summary from the language model 606, which the language model generates based on the user input provided in a structured prompt. The prompt to the language model 606 may include the raw user input along with instructions to generate a concise case title and executive summary that captures the essential elements of the marketing challenge. As such, unstructured user descriptions are transformed into organized case documentation. At step 616, the MIO platform 604 creates a record in the database 608 for the case, storing the structured case information for subsequent analysis and retrieval. In some implementations, this record may include metadata such as user identifiers, timestamps, industry classifications, and preliminary challenge categorizations that facilitate efficient case management and historical analysis. At step 618, a command is received from the client 602 to analyze the case, triggering the automated module recommendation process. This command may be initiated through user interface controls that allow marketers to proceed from case creation to solution generation, as illustrated in the user interface examples described in the detailed description.

At step 620, the MIO platform 604 causes the language model 606 to perform a journey analysis by providing a prompt that includes the case details and requests identification of applicable predefined journeys. A “journey” in this context refers to a predefined solution pattern that maps specific types of marketing challenges to recommended module sequences and analytical workflows, as described in the detailed description. For example, a journey titled “Boost Partial Plan Upgrades” may include a sequence of modules such as segmentation, loyalty scoring, and upgrade propensity analysis specifically designed for sports industry applications. At step 622, the language model 606 returns a list of applicable journeys that align with the case characteristics. In some implementations, this list may be ranked by relevance scores determined through semantic similarity analysis between the case description and journey definitions stored in the system’s knowledge base.

At step 624, the MIO platform 604 queries the database 608 for matching strategies using a combination of module identifiers, industry classifications, and journey selections. A “strategy” in this disclosure refers to a specific combination of modules configured for particular industry contexts and analytical objectives, representing the executable implementation of a journey pattern. This query leverages the stored problem-strategy mappings described in the detailed description to identify technically compatible and contextually relevant module combinations. At step 626, the database 608 returns the applicable strategies to the MIO platform 604. In some implementations, these strategies may include dependency information, execution sequence requirements, and performance metrics from previous implementations to inform the selection process.

At step 628, the MIO platform 604 engages the language model 606 to evaluate the retrieved modules against the case by providing a prompt that includes both the case details and the module descriptions. This evaluation process implements the CAG functionality described in the detailed description, where domain-specific knowledge and contextual constraints are applied to refine module selection beyond simple keyword matching. At step 630, the language model 606 analyzes the module descriptions against the case language to determine semantic alignment and contextual appropriateness. In some implementations, this analysis may incorporate industry-specific terminology, challenge complexity assessments, and expected outcome alignment to generate relevance scores for each candidate module.

At step 632, a predefined number of the top matching strategies is returned by the language model 606 to the MIO platform 604. In the illustrated example, the predefined number is seven, though alternative implementations may employ different thresholds based on case complexity or user preferences. This limitation ensures that users receive a manageable set of high-quality recommendations rather than an overwhelming array of possibilities. At step 634, the MIO platform 604 creates a solution record in the database 608 that documents the recommended strategies and their associated justifications. This record may serve multiple purposes including audit trail maintenance, performance tracking, and feedback loop implementation for continuous system improvement.

At step 636, the MIO platform 604 receives an analysis summary and justifications from the language model 606, generated through prompting that requests explanatory text describing why specific modules were selected and how they address the stated marketing challenge. These justifications implement the explainability requirements described in the detailed description, ensuring that users can understand and validate the automated recommendations. At step 638, the analysis summary and justifications are displayed to the user at the client 602 through the user interface, completing the recommendation workflow. In some implementations, this display may include interactive elements that allow users to explore alternative strategies, modify selections, or proceed directly to module execution as described in the subsequent workflow steps of the system.

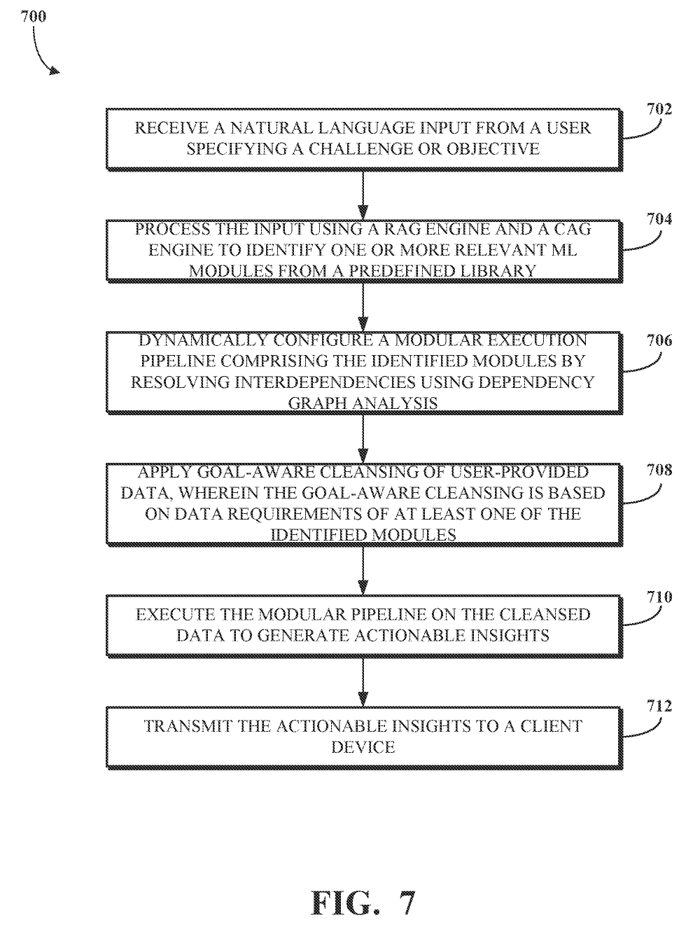

FIG. 7 is a flowchart of an example of a technique 700 associated with modular ML workflows for actionable insights from natural language. The technique 700 implements an end-to-end computer-implemented technique for automatically constructing and executing domain-specific analytical workflows by processing natural language inputs and dynamically assembling machine learning modules from a specialized registry. The technique 700 may be implemented by the MIO platform 106 and executed by the system 100 shown in FIG. 1.

At step 702, the technique 700 receives a natural language input from a user specifying a challenge or objective. For example, the MIO platform 106 may receive user input through the client 102 interface, where users can specify marketing challenges, business objectives, or analytical goals expressed in natural language without requiring technical expertise in machine learning configuration. The natural language input may include industry specifications such as “Baseball,” challenges such as “we have been on a losing streak for the past 8 months and our ball park has been only 80% full,” and goals such as “I want to know who are the loyal fans that I can reach out to and make them come out to see us, win or lose,” as described in connection with FIG. 5A.

At step 704, the technique 700 processes the input a RAG engine and a CAG engine to identify one or more relevant machine learning modules from a predefined library. The RAG and CAG engines may be implemented as functional components of the language model 108 and recommendation engine 360, where the language model 108 performs retrieval-augmented generation to identify candidate modules and the recommendation engine 360 applies context-augmented guidance to refine selections based on domain-specific criteria. For example, the MIO platform 106 may employ the language model 108 to implement RAG techniques that dynamically retrieve potentially relevant modules and workflow components from the module library 306, as described in connection with FIG. 3A. The language model 354 and recommendation engine 360 (FIG. 3B) may parse the user input to retrieve relevant module candidates from the module registry 356.

In some implementations, the RAG engine retrieves module candidates from a registry and the CAG engine filters the candidates based on journey mappings and domain-specific optimization logic. The CAG engine may refine module selection based on at least one of user industry, historical usage patterns, organizational metadata, or journey templates. The journey templates can be stored in a human-curated strategy corpus authored by, for example, marketing executives and data scientists and includes strategy records authored by marketing executives and data scientists, each record including a user problem statement, module-derived audience insight, strategy applied, observed uplift metrics, and lessons learned. For instance, if the user input references a sports domain and a goal to improve retention, RAG might retrieve general-purpose churn modules, but CAG would prioritize fan engagement and loyalty models optimized for ticket renewals, as described in connection with the mapping 308.

The CAG engine may then refine this list using domain-specific mappings, historical user patterns, organizational context, or predefined journeys 358. Alternative implementations may employ rule-based intent parsing instead of or in addition to RAG, use heuristic-based dependency resolution, or support asynchronous module selection for real-time applications.

At step 706, the technique 700 dynamically configures a modular execution pipeline that includes the identified modules by resolving interdependencies using dependency graph analysis. As mentioned above, that the pipeline includes the identified modules includes that the pipeline includes a subset of the identified modules, as selected by a user. The configuration engine of the MIO platform 106 may employ dependency graph analysis and semantic scoring to dynamically assemble modules into the modular execution pipeline 366 that maintains valid data flows and performs context-sensitive optimization, as described in connection with step 314 of FIG. 3A. The configuration engine 364 is configured to dynamically assemble based on semantic parsing of user input, RAG-based document retrieval, and CAG-driven module validation logic. The configuration engine 364 (see FIG. 3B) may model the modules as nodes and define edges based on data flow dependencies.

In some implementations, the dependency graph analysis models modules as nodes and inter-module data dependencies as edges, and determines execution order using topological sorting or priority-based scheduling. The configuration engine may use the mapping 308 to analyze selected modules and their interdependencies to establish an optimal execution sequence, constructing a directed acyclic graph (DAG) that defines the execution order while ensuring that certain analytical operations precede others, such as ensuring clustering precedes prediction.

The configuration engine includes or can access a module registry, a dependency graph resolver, and a semantic scoring function, which together determine an optimal execution sequence. In some implementations, semantic scoring and historical performance data 368 may influence the ordering. Alternative implementations may employ heuristic-based dependency resolution, parallel execution frameworks for independent modules, or dynamic reconfiguration capabilities that adapt pipeline structure based on real-time performance metrics and resource availability.

The technique 700 can include ingesting user-provided data into the pipeline, where the data ingestion component implements metadata-aware processing that considers data lineage and freshness to optimize preprocessing, as described in connection with step 312 of FIG. 3A. For example, the data ingestion component of the MIO platform 106 (shown in FIG. 1) may ingest first-party data like ticket purchase history, sales records, customer profiles, and engagement metrics. In some implementations, the data may include first-party customer interaction data, second-party data, third-party data such as demographic or behavioral data, or transactional records that enable comprehensive analytical processing from the data source 112.

The technique 700 may ingest data from a CRM or analytics platform (e.g., customer demographics, transaction histories), offering flexibility for diverse data sources. The ingested data may include structured or unstructured formats, processed securely with encryption for compliance. Alternative implementations may support streaming data inputs, integrate third-party data sources via Application Programming Interfaces (APIs), or implement real-time data validation and quality assessment procedures.

At step 708, the technique 700 applies goal-aware cleansing of the user-provided data, wherein the goal-aware cleansing is based on data requirements of at least one of the identified modules. For example, the data ingestion component of the MIO platform 106 may implement goal-aware data preparation that dynamically adjusts cleansing and transformation based on downstream module requirements, such as preserving categorical variability for clustering tasks or prioritizing imputation for price sensitivity features, as described in connection with step 508 of FIG. 5A.

In some implementations, the goal-aware cleansing comprises schema detection, data type validation, missing value handling, or categorical encoding specific to the data requirements of the selected modules. The system may apply schema alignment, null value handling, or categorical encoding based on the expected input format of a module. The goal-aware cleansing process may include dynamic feature prioritization, context-specific imputation strategies, and adaptive data quality thresholds that align preprocessing operations with downstream module requirements.

In some implementations, this data preparation step may use AI-assisted detection of cleansing rules relevant to the module set. Alternative implementations may incorporate human validation for complex anomalies, enhancing data quality for diverse analytical tasks, support automated feature selection, real-time preprocessing for streaming applications, or machine learning-based data quality assessment that adapts cleansing procedures based on detected data patterns and module-specific sensitivities.

At step 710, the technique 700 executes the modular pipeline on the cleansed data to generate actionable insights. For example, the MIO platform 106 may process the user data through the configured sequence of modules according to the execution pipeline 366, where pipeline execution includes data transformations, feature engineering and derivation, customer clustering, predictive modeling, and explainability analysis, as described in connection with step 318 of FIG. 3A. In some implementations, execution may occur in a scalable, cloud-based environment with real-time logging for traceability.

In some implementations, at least one of the ML modules includes at least one of a dimensionality reduction layer, an executive logic reasoning layer for deriving behavioral traits, a clustering layer, a predictive modeling layer, and an explainability layer. The executive logic reasoning layer may include one or more ML models configured to derive behavioral traits selected from loyalty, fandom, price sensitivity, and enthusiasm, as shown by components 414, 416, 418, and 420 in the module 402 of FIG. 4. The executive logic reasoning layer generates engineered behavioral features using embedded machine learning models before applying statistical modeling operations. The executive logic reasoning layer includes embedded models selected from logistic regression, uplift modeling, LSTM neural networks, and embedding models that derive behavioral traits including loyalty scores, price sensitivity metrics, fandom classifications, and enthusiasm vectors.

In some implementations, executing the modular pipeline includes applying a clustering algorithm to segment user data and a predictive model to score behavioral outcomes, where the clustering algorithm is KMeans and the predictive model is XGBoost, logistic regression, or a neural network, as shown by components 422 and 424 in FIG. 4. The modules may employ a reasoning-first architecture where behavioral signals such as customer loyalty indicators, engagement enthusiasm metrics, or price sensitivity scores are derived through executive logic before statistical modeling operations, thereby improving model explainability and enhancing the utility of downstream analytical results by providing semantically meaningful features for machine learning algorithms.

The pipeline may be executed in a cloud-native architecture using containerized modules that support asynchronous execution and parallel scaling. This enables the system to dynamically adapt to workloads and support both real-time and batch processing modes. Alternative implementations may support multi-tenant isolation on the server 104 (shown in FIG. 1), allowing multiple organizations to use the MIO platform 106 simultaneously.

At step 712, the technique 700 transmits the actionable insights to a client device. For example, the MIO platform 106 may deliver multi-layered insight delivery through the client 102 interface, providing visual dashboards with specialized tabs, AI-generated textual summaries, predictive scores, and activation-ready datasets for integration with external platforms, as described in connection with step 320 of FIG. 3A. The insights may include natural language summaries generated by a Reporter Agent, visual dashboards showing segments or scores, and activation-ready datasets for downstream systems.

In some implementations, the actionable insights include an AI-generated textual summary, a visual dashboard, and an activation-ready output for integration with a downstream system, where the downstream system is selected from a CDP, a CRM system, a DSP, or an email automation system. The insight generation may create visualization dashboards such as those shown in FIGS. 5D, 5E, 5F, and 5G, with customer segment profiles, segmentations, narrative explanations, and activation-ready datasets formatted for downstream systems like customer data platforms or demand-side platforms.

The technique 700 can include generating an explainability output using a SHAP model or a LIME model that identifies contributions of individual behavioral features to each prediction. For example, the explainability layer 410 may employ SHAP techniques to generate interpretable explanations for the analytical outputs, as demonstrated by component 426 in the module 402 of FIG. 4. This allows users to understand why a particular user segment received a high conversion score or was prioritized for re-engagement.

The technique 700 can include invoking one or more AI agents to generate natural language summaries of pipeline outputs, structured-query-language-based reports, strategic recommendations, or activation-ready instructions. For example, the MIO platform 106 may implement specialized AI agents such as reporter AI agents for generating insights summaries and expert AI agents for providing detailed explanations and responding to follow-up questions, as described in connection with FIGS. 5H and 5I. In some implementations, an expert AI agent may generate strategic recommendations or targeting instructions for campaign execution.

These AI agents enable users to ask follow-up questions such as “Which customer segment is most likely to respond to a discount offer?” and receive explanations that integrate model attribution techniques with executive logic reasoning. The AI agents may be implemented as specialized language models fine-tuned for domain-specific explanation generation and interactive question answering, processing computational outputs from the selected modules and converting them into narrative explanations, strategic recommendations, and practical guidance suitable for non-technical users. Alternative implementations may allow agent-driven conversational analysis for longitudinal insights.

The technique 700 can include receiving user feedback regarding insight quality or accuracy and updating one or more of the RAG, CAG, or semantic scoring components based on said feedback. For example, the MIO platform 106 may implement iterative feedback mechanisms where user interactions, output validations, and performance metrics are captured to continuously refine future module selection algorithms, pipeline design optimization, and data preprocessing logic, as described in connection with the feedback mechanism with respect to FIG. 3B. The system may detect that certain modules yield consistently actionable outputs in sports analytics contexts and prioritize those during future configuration.

The disclosure may extend to alternative implementations where the pipeline may be adapted for financial services, such as fraud detection, by incorporating specialized modules like anomaly detection. These variations enhance the system's adaptability across diverse domains and use cases, including applications in healthcare (e.g., patient risk stratification), logistics (e.g., demand forecasting and route optimization), or human resources (e.g., attrition prediction and workforce planning). Overall, the technique 700 transforms an unstructured natural language input into a structured, explainable, and context-sensitive execution pipeline tailored to a specific business challenge, enabling non-technical users to generate and deploy advanced machine learning workflows with minimal manual configuration, while preserving transparency and adaptability through dynamic configuration, explainability, and feedback-driven refinement.

The techniques described herein, such as the techniques 300, 350, 500, and 700 of FIGS. 3A, 3B, 5A, and 7, respectively, including another techniques, method, process, or algorithm described in connection with the implementations disclosed herein can be executed using computing devices, such as the systems, hardware, and software described with respect to FIGS. 1-5I. Each of the techniques can be performed, for example, by executing a machine-readable program or other computer-executable instructions, such as routines, instructions, programs, or other code. The steps, or operations, of each of the techniques can be implemented directly in hardware, firmware, software executed by hardware, circuitry, or a combination thereof.

For simplicity of explanation, the techniques 300, 350, 500, and 700 are each depicted and described herein as a respective series of steps or operations. However, the steps or operations of each of the techniques 300, 350, 500, and 700 can occur in various orders and/or concurrently. Additionally, other steps or operations not presented and described herein may be used. Furthermore, not all illustrated steps or operations may be required to implement a technique in accordance with the disclosed subject matter.

As used herein, unless explicitly stated otherwise, any term specified in the singular may include its plural version. For example, “a computer that stores data and runs software,” may include a single computer that stores data and runs software or two computers – a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A computer-implemented method, comprising:
receiving a natural language input from a user specifying a challenge or objective;
processing the input using a retrieval-augmented generation (RAG) engine and context-augmented guidance (CAG) engine to identify one or more relevant machine learning modules from a predefined library;
dynamically configuring a modular execution pipeline comprising the identified modules by resolving interdependencies using dependency graph analysis that models modules as nodes and inter-module data dependencies as edges;
applying goal-aware cleansing of user-provided data, wherein the goal-aware cleansing is based on data requirements of at least one of the identified modules;
executing the modular pipeline on the cleansed data to generate actionable insights; and
transmitting the actionable insights to a client device.

2. The method of claim 1, wherein at least one of the machine learning modules includes at least one of:
a dimensionality reduction layer,
an executive logic reasoning layer for deriving behavioral traits and that generates engineered behavioral features using embedded machine learning models before applying statistical modeling operations,
a clustering layer,
a predictive modeling layer, and
an explainability layer.

3. The method of claim 2, wherein the executive logic reasoning layer comprises one or more machine learning models configured to derive behavioral traits selected from: loyalty, fandom, price sensitivity, and enthusiasm.

4. The method of claim 1, wherein the dependency graph analysis is configured to model modules as nodes and inter-module data dependencies as edges, and determines execution order using topological sorting or priority-based scheduling.

5. The method of claim 1, wherein the CAG engine refines module selection based on at least one of user industry, historical usage patterns, organizational metadata, or journeys.

6. The method of claim 1, wherein the goal-aware cleansing comprises schema detection, data type validation, missing value handling, or categorical encoding specific to the data requirements of the identified modules.

7. The method of claim 1, wherein executing the modular pipeline comprises:
applying a clustering algorithm to segment user data and a predictive model to score behavioral outcomes.

8. The method of claim 7, wherein the clustering algorithm is KMeans and the predictive model is XGBoost, logistic regression, or a neural network.

9. A system, comprising:
a memory subsystem; and
processing circuitry, the processing circuitry configured to execute instructions stored in the memory subsystem to:
receive a natural language input from a user specifying a challenge or objective;
process the input using a retrieval-augmented generation (RAG) engine and context-augmented guidance (CAG) engine to identify one or more relevant machine learning modules from a predefined library;
dynamically configure a modular execution pipeline comprising the identified modules by resolving interdependencies using dependency graph analysis that models modules as nodes and inter-module data dependencies as edges;
apply goal-aware cleansing of user-provided data, wherein the goal-aware cleansing is based on data requirements of at least one of the identified modules;
execute the modular pipeline on the cleansed data to generate actionable insights; and
transmit the actionable insights to a client device.

10. The system of claim 9, wherein the processing circuitry further configured to execute instructions stored in the memory subsystem to:
generate an explainability output using a SHapley Additive exPlanations (SHAP) model or a Local Interpretable Model-agnostic Explanations (LIME) model that identifies contributions of individual behavioral features to each prediction.

11. The system of claim 9, wherein the processing circuitry further configured to execute instructions stored in the memory subsystem to:
receive user feedback regarding insight quality or accuracy; and
update one or more of the RAG, CAG, or semantic scoring components based on said feedback.

12. The system of claim 9, wherein the RAG engine retrieves module candidates from a registry and the CAG engine filters the candidates based on journey mappings and domain-specific optimization logic.

13. The system of claim 9, wherein the actionable insights include an AI-generated textual summary, a visual dashboard, and an activation-ready output for integration with a downstream system.

14. The system of claim 13, wherein the downstream system is selected from a customer data platform (CDP), customer relationship management (CRM) system, demand-side platform (DSP), or email automation system.

15. The system of claim 13, wherein the processing circuitry further configured to execute instructions stored in the memory subsystem to:
invoke one or more AI agents to generate natural language summaries of pipeline outputs, structured-query-language-based reports, strategic recommendations, or activation-ready instructions.

16. One or more non-transitory computer readable media storing instructions that, when executed by one or more processors, perform operations comprising:
receiving a natural language input from a user specifying a challenge or objective;
processing the input using a retrieval-augmented generation (RAG) engine and context-augmented guidance (CAG) engine to identify one or more relevant machine learning modules from a predefined library;
dynamically configuring a modular execution pipeline comprising the identified modules by resolving interdependencies using dependency graph analysis that models modules as nodes and inter-module data dependencies as edges;
applying goal-aware cleansing of user-provided data, wherein the goal-aware cleansing is based on data requirements of at least one of the identified modules;
executing the modular pipeline on the cleansed data to generate actionable insights; and
transmitting the actionable insights to a client device.

17. The one or more non-transitory computer readable media of claim 16, wherein the operations further comprise:
generating an explainability output using a SHapley Additive exPlanations (SHAP) model or a Local Interpretable Model-agnostic Explanations (LIME) model that identifies contributions of individual behavioral features to each prediction.

18. The one or more non-transitory computer readable media of claim 16, wherein the operations further comprise:
receiving user feedback regarding insight quality or accuracy; and
updating one or more of the RAG, CAG, or semantic scoring components based on said feedback.

19. The one or more non-transitory computer readable media of claim 16, wherein the RAG engine retrieves module candidates from a registry and the CAG engine filters the candidates based on journey mappings and domain-specific optimization logic.

20. The one or more non-transitory computer readable media of claim 16, wherein the CAG engine refines module selection based on at least one of user industry, historical usage patterns, organizational metadata, or journeys.
